(19) United States
(12) Patent Application Publication
(10) Pub. No.: US 2026/0038438 A1
(43) Pub. Date: Feb. 5, 2026

(54) PIXEL CIRCUIT AND DISPLAY DEVICE INCLUDING THE SAME

(71) Applicant: SAMSUNG DISPLAY CO., LTD., YONGIN-SI (KR)

(72) Inventor: JUNHYUN PARK, Yongin-si (KR)

(21) Appl. No.: 19/276,224

(22) Filed: Jul. 22, 2025

(30) Foreign Application Priority Data
Jul. 30, 2024 (KR) 10-2024-0100973
Jan. 23, 2025 (KR) 10-2025-0010149

(51) Int. Cl. G09G 3/3233

(52) U.S. Cl. CPC G09G 3/3233; G09G 2300/0465; G09G 2300/0819; G09G 2300/0852; G09G 2310/08

(57) ABSTRACT

The present application provides a pixel circuit and a display device. The pixel circuit includes a first transistor including a first gate electrode connected to a first node, a first electrode receiving a first power supply voltage, a second electrode connected to a second node, and a second gate electrode connected to a third node, a second transistor configured to connect a data line and the first node in response to a data write gate signal, a third transistor configured to provide a reference voltage to the third node in response to a compensation gate signal, a first capacitor including a first electrode connected to the first node and a second electrode connected to the second node, a second capacitor including a first electrode connected to the second node and a second electrode connected to the third node, and a light emitting element including an anode connected to the second node and a cathode receiving a second power supply voltage.

This application claims priority under 35 U.S.C. § 119 to Korean Patent Application No. 10-2024-0100973, filed on Jul. 30, 2024, and Korean Patent Application No. 10-2025-0010149, filed on Jan. 23, 2025 in the Korean Intellectual Property Office (KIPO), the contents of which are herein incorporated by reference in their entireties.

### FIELD

This disclosure relates to a pixel circuit and a display device including the same.

### DESCRIPTION OF THE RELATED ART

In general, a display device includes a display panel and a display panel driver. The display panel includes gate lines, data lines, and pixel circuits. The display panel driver includes a gate driver for providing a gate signal to the gate lines, a data driver for providing a data voltage to the data lines, and a driving controller for controlling the gate driver and the data driver.

Recently, display devices that provide virtual reality (VR) or augmented reality (AR) have been developed. For this purpose, the display panel of the display device may be small (e.g., the size of eye glasses) and have high PPI (Pixels Per Inch). In this case, since a pitch between pixel circuits needs to be narrow, there may be restrictions on a number of transistors within each pixel circuit and a signal applied to the pixel circuit.

### SUMMARY

Embodiments of the present inventive concept provide a pixel circuit occupying a small area in a display device, and allow for a high PPI for the display device.

Embodiments of the present inventive concept provide a display device including the pixel circuit.

In an embodiment of a pixel circuit according to the present inventive concept, the pixel circuit includes a first transistor including a first gate electrode connected to a first node, a first electrode connected to receive a first power supply voltage, a second electrode connected to a second node, and a second gate electrode connected to a third node, a second transistor configured to connect a data line and the first node in response to a data write gate signal, a third transistor configured to provide a reference voltage to the third node in response to a compensation gate signal, a first capacitor including a first electrode connected to the first node and a second electrode connected to the second node, a second capacitor including a first electrode connected to the second node and a second electrode connected to the third node, and a light emitting element including an anode connected to the second node and a cathode connected to receive a second power supply voltage.

The first to third transistors may be NMOS transistors.

The second transistor may include a gate electrode receiving the data write gate signal, a first electrode connected to the data line, and a second electrode connected to the first node.

The third transistor may include a gate electrode receiving the compensation gate signal, a first electrode receiving the reference voltage, and a second electrode connected to the third node.

The first gate electrode of the first transistor may be a gate electrode and the second gate electrode of the first transistor may be a back gate electrode.

The first gate electrode of the first transistor may be a back gate electrode and the second gate electrode of the first transistor may be a gate electrode.

The pixel circuit may further comprise a fourth transistor configured to connect the first node and the second node in response to a second compensation gate signal.

The fourth transistor may include a gate electrode receiving the second compensation gate signal, a first electrode connected to the first node, and a second electrode connected to the second node.

The pixel circuit may further comprise a fifth transistor configured to provide an initialization voltage to the second node in response to an initialization gate signal.

The fifth transistor may include a gate electrode receiving the initialization gate signal, a first electrode receiving the initialization voltage, and a second electrode connected to the second node.

In an embodiment of a pixel circuit according to the present inventive concept, the pixel circuit includes a first transistor including a first gate electrode connected to a first node, a first electrode receiving a first power supply voltage, a second electrode connected to a second node, and a second gate electrode connected to the second node, a first capacitor including a first electrode connected to the first node and a second electrode connected to a third node, a second transistor configured to connect a data line and the third node in response to a data write gate signal, a third transistor configured to provide a reference voltage to the first node in response to a compensation gate signal, a fourth transistor configured to connect the second node and the third node in response to the compensation gate signal, a second capacitor including a first electrode connected to the second node and a second electrode connected to the third node, and a light emitting element including an anode connected to the second node and a cathode receiving a second power supply voltage.

In an embodiment of an electronic device according to the present inventive concept, the electronic device includes a display panel including a pixel circuit, a gate driver configured to provide a gate signal to the pixel circuit, a data driver configured to provide a data voltage to the pixel circuit, and a driving controller configured to control the gate driver and the data driver. The pixel circuit comprises a first transistor including a first gate electrode connected to a first node, a first electrode receiving a first power supply voltage, a second electrode connected to a second node, and a second gate electrode connected to a third node, a second transistor configured to connect a data line and the first node in response to a data write gate signal, a third transistor configured to provide a reference voltage to the third node in response to a compensation gate signal, a first capacitor including a first electrode connected to the first node and a second electrode connected to the second node, a second capacitor including a first electrode connected to the second node and a second electrode connected to the third node, and a light emitting element including an anode connected to the second node and a cathode receiving a second power supply voltage.

According to the pixel circuit and the electronic device, the pixel circuit may have a small number of transistors and capacitors. Accordingly, the pixel circuit may occupy a small area and allow for a high PPI in the display device.

### BRIEF DESCRIPTION OF THE DRAWINGS

The above and other features of embodiments of the present inventive concept will become more apparent by describing in detailed embodiments thereof with reference to the accompanying drawings, in which:

FIG. 1 is a block diagram showing a display device according to embodiments of the present inventive concept;

FIG. 2 is a circuit diagram showing an example of a pixel circuit of FIG. 1;

FIG. 3 is a timing diagram showing an example of operating a pixel circuit of FIG. 2;

FIG. 4 is a circuit diagram showing an example of operating a pixel circuit of FIG. 2 in a first duration of FIG. 3;

FIG. 5 is a circuit diagram showing an example of operating a pixel circuit of FIG. 2 in a second duration of FIG. 3;

FIG. 6 is a circuit diagram showing an example of operating a pixel circuit of FIG. 2 in a third duration of FIG. 3;

FIG. 7 is a circuit diagram showing an example of operating a pixel circuit of FIG. 2 in a fourth duration of FIG. 3;

FIG. 8 is a circuit diagram showing an example of a pixel circuit of FIG. 1;

FIG. 9 is a circuit diagram showing an example of a pixel circuit of FIG. 1;

FIG. 10 is a timing diagram showing an example of operating a pixel circuit of FIG. 9;

FIG. 11 is a circuit diagram showing an example of operating a pixel circuit of FIG. 9 in a first duration of FIG. 10;

FIG. 12 is a circuit diagram showing an example of operating a pixel circuit of FIG. 9 in a second duration of FIG. 10;

FIG. 13 is a circuit diagram showing an example of operating a pixel circuit of FIG. 9 in a third duration of FIG. 10;

FIG. 14 is a circuit diagram showing an example of operating a pixel circuit of FIG. 9 in a fourth duration of FIG. 10;

FIG. 15 is a circuit diagram showing an example of a pixel circuit of FIG. 1;

FIG. 16 is a timing diagram showing an example of operating a pixel circuit of FIG. 15;

FIG. 17 is a circuit diagram showing an example of operating a pixel circuit of FIG. 15 in a first duration of FIG. 16;

FIG. 18 is a circuit diagram showing an example of operating a pixel circuit of FIG. 15 in a second duration of FIG. 16;

FIG. 19 is a circuit diagram showing an example of operating a pixel circuit of FIG. 15 in a third duration of FIG. 16;

FIG. 20 is a circuit diagram showing an example of operating a pixel circuit of FIG. 15 in a fourth duration of FIG. 16;

FIG. 21 is a circuit diagram showing an example of a pixel circuit of FIG. 1;

FIG. 22 is a timing diagram showing an example of operating a pixel circuit of FIG. 21;

FIG. 23 is a circuit diagram showing an example of operating a pixel circuit of FIG. 21 in a first duration of FIG. 22;

FIG. 24 is a circuit diagram showing an example of operating a pixel circuit of FIG. 21 in a second duration of FIG. 22;

FIG. 25 is a circuit diagram showing an example of operating a pixel circuit of FIG. 21 in a third duration of FIG. 22;

FIG. 26 is a circuit diagram showing an example of operating a pixel circuit of FIG. 21 in a fourth duration of FIG. 22;

FIG. 27 is a block diagram showing an electronic device according to embodiments of the present inventive concept;

FIG. 28 is a diagram showing an example in which an electronic device of FIG. 27 is implemented as a VR device;

FIG. 29 is a block diagram showing an electronic device according to embodiments of the present inventive concept; and

FIG. 30 is a schematic diagram of an electronic device of FIG. 29.

### DETAILED DESCRIPTION OF EMBODIMENTS

Hereinafter, embodiments of the present inventive concept will be described in more detail with reference to the accompanying drawings.

In embodiments of the inventive concept such as those described hereafter, a pixel circuit has a configuration that allows for threshold voltage compensation of a driving transistor for an emission element. As compared to prior art pixel circuits with similar functionality, the pixel circuit may utilize a smaller number of transistors, resulting in a pixel circuit occupying a smaller area and enabling construction of a display device with a higher PPI. To this end, a pixel circuit of embodiments herein may have as little as three transistors, including a first transistor connected to a data line, a second transistor that receives a “compensation gate signal”, and a third (driving) transistor for driving an emission element. A pair of capacitors may be connected in series between a front gate and a back gate of the driving transistor. A node between the capacitors connects an electrode (e.g., a source electrode) of the driving transistor and an anode of the emission element. During a compensation period prior to a data write period, signals and voltages may be applied to cause each of the capacitors to pre-charge and store a voltage equaling a threshold voltage of the driving transistor. In the absence of any threshold compensation, variations among the threshold voltages may exist from pixel circuit to pixel circuit, causing visible artifacts. In the pixel circuits described herein, during a data writing period, at least one of the capacitors may charge up to store a voltage that is based on both the data voltage and the threshold voltage, thereby removing deleterious effects of threshold voltage variations. In some embodiments, an additional one or more transistors are added to provide more functionality.

Herein, when a threshold voltage of a transistor is said to be “compensated”, this may generally mean that threshold voltage compensation circuitry may supply voltage/current to the transistor to change an overall circuit action or inaction that that results from an uncompensated threshold voltage for that transistor. A threshold voltage may be understood as a minimum gate-to-source voltage for creating a conducting path between the drain and source of the transistor.

In the description hereafter, for brevity, a circuit element/parameter (e.g., a transistor or a voltage) initially introduced by a name and a label may be later referred to just by the label (e.g., “ELVDD(H)”) or a shortened version of the name followed by the label (e.g., “voltage ELVDD(H)”).

Herein, when a first circuit element is said to be “connected” to a second circuit element, the connection may be a direct connection in which no other intervening circuit element is connected between the first and second circuit elements, such as may be illustrated in the schematic diagrams of embodiments herein. However, this does not preclude the existence of an intervening circuit element(s) between the first and second circuit elements in other embodiments, provided that the particular intervening circuit element(s) would not defeat the purpose of the direct connection between the first and second circuit elements.

Herein, a “first electrode” of an N-channel or P-channel Metal Oxide Semiconductor Field Effect Transistor (an “NMOS” or a “PMOS”) is a source electrode or a drain electrode of the transistor, and a “second electrode” of the transistor is the other of the source electrode and the drain electrode.

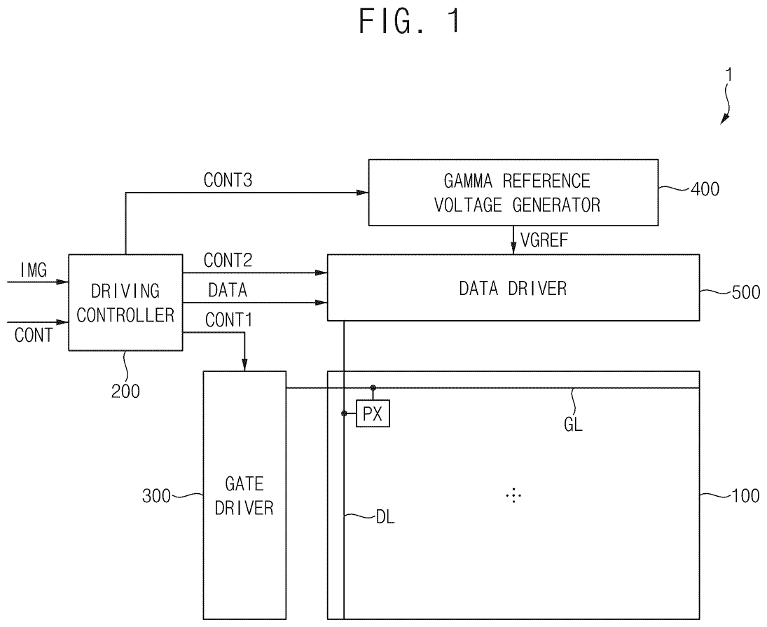

FIG. 1 is a block diagram showing a display device 1 according to embodiments of the present inventive concept.

Referring to FIG. 1, a display device 1 may include a display panel 100 and a display panel driver. The display panel driver may include a driving controller 200, a gate driver 300, a gamma reference voltage generator 400, and a data driver 500.

For example, the driving controller 200 and the data driver 500 may be formed integrally. The driving controller 200, the gamma reference voltage generator 400, and the data driver 500 may be formed integrally. The driving controller 200, the gate driver 300, the gamma reference voltage generator 400, and the data driver 500 may be formed integrally. A driving module in which at least the driving controller 200 and the data driver 500 are formed integrally may be called a Timing Controller Embedded Data Driver (TED).

The display panel 100 may include a display area for displaying an image and a peripheral area arranged adjacent to the display area.

For example, the display panel 100 may be an organic light emitting diode (OLED) display panel including an organic light emitting diode. As another example, the display panel 100 may be a quantum dot organic light emitting diode display panel including an organic light emitting diode and a quantum dot color filter. In another example, the display panel 100 may be a quantum dot nano light emitting diode display panel including a nano light emitting diode and a quantum dot color filter. In still another example, the display panel 100 may be a liquid crystal display (LCD) panel including a liquid crystal layer.

The display panel 100 may include gate lines GL, data lines DL, and pixel circuits PX electrically connected to each of the gate lines GL and the data lines DL. The gate lines GL may extend in a first direction, and the data lines DL may extend in a second direction intersecting the first direction.

The driving controller 200 may receive input image data IMG and an input control signal CONT from an external device (not shown). For example, the input image data IMG may include red image data, green image data, and blue image data. The input image data IMG may include white image data. The input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONT1 for controlling an operation of the gate driver 300 based on the input control signal CONT, and output the first control signal CONT1 to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals for driving the gate lines GL in response to the first control signal CONT1 received from the driving controller 200. The gate driver 300 may sequentially output the gate signals to the gate lines GL.

In an embodiment, the gate driver 300 may be integrated in the peripheral area of the display panel 100.

The gamma reference voltage generator 400 may generate a gamma reference voltage VGREF based on the third control signal CONT3 received from the driving controller 200. The gamma reference voltage generator 400 may provide the gamma reference voltage VGREF to the data driver 500. The gamma reference voltage VGREF may have a value corresponding to each data signal DATA.

In an embodiment, the gamma reference voltage generator 400 may be arranged within the driving controller 200 or within the data driver 500.

The data driver 500 may receive the second control signal CONT2 and the data signal DATA from the driving controller 200, and may receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

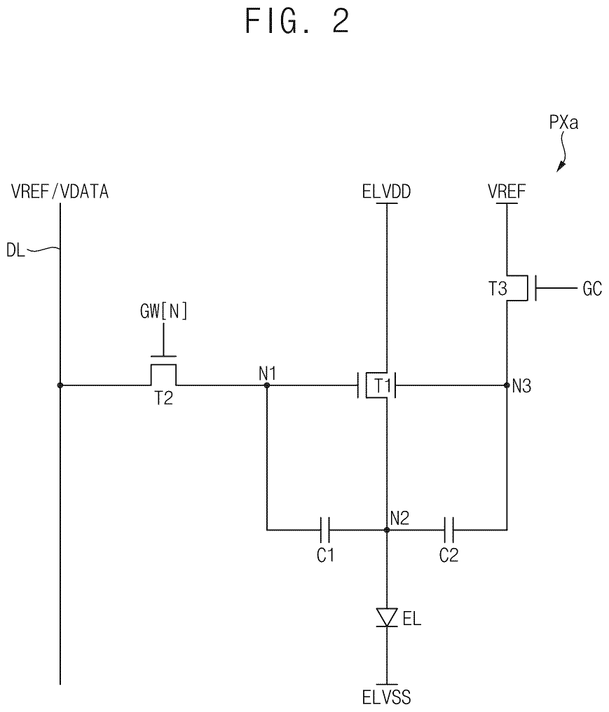

FIG. 2 is a circuit diagram showing a pixel circuit PXa, which is an example of the pixel circuit PX of FIG. 1.

Referring to FIG. 2, a pixel circuit PXa may include a first transistor T1, a second transistor T2, a third transistor T3, a first capacitor C1, a second capacitor C2, and a light emitting element EL. In an embodiment, the first to third transistors T1 to T3 may be NMOS transistors. In another embodiment, the first transistor T1 may be the NMOS transistor, and the second to third transistors T2 to T3 may be PMOS transistors. Some examples of the light emitting element EL include an OLED, an LCD, an inorganic LED and a nano LED.

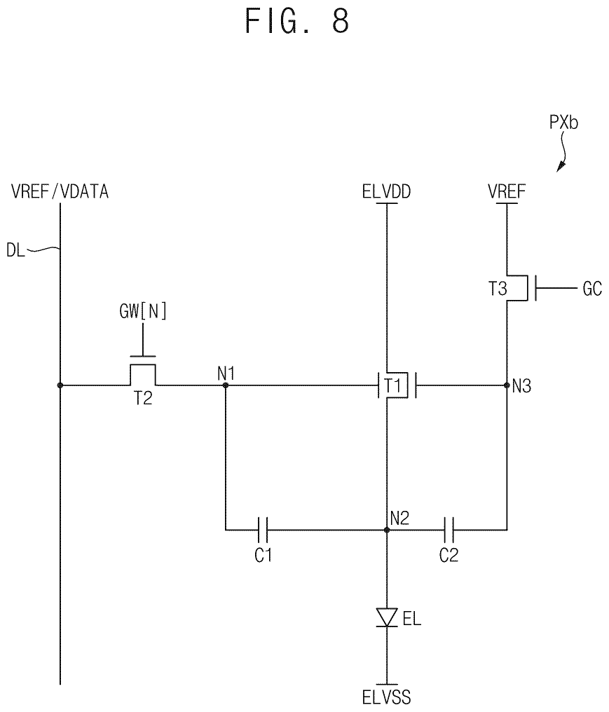

Any of the NMOS transistors may be turned on in response to a gate signal applied thereto having a high level, and may be turned off in response to the applied gate signal having a low level. Any of the PMOS transistors may be turned on in response to a gate signal applied thereto having a low level (not necessarily the same level as the low level as that applied to the NMOS transistors), and may be turned off in response to the applied gate signal having a high level (not necessarily the same high level as that applied to the NMOS transistors). It is noted here that the same ON/OFF operations of the NMOS and PMOS transistors as a function of the gate signals applied thereto is applicable to the pixel circuits PXb, PXc, PXd, and PXe of FIGS. 8, 9, 15 and 21.

The first transistor T1 may include a first gate electrode connected to a first node N1, a first electrode connected to receive a first power supply voltage ELVDD, a second electrode connected to a second node N2, and a second gate electrode connected to a third node N3. In an embodiment, the first gate electrode of the first transistor T1 may be a gate electrode (sometimes called a “front gate electrode”), and the second gate electrode of the first transistor T1 may be a back gate electrode. The first transistor T1 may generate a driving current based on a voltage of the first node N1 and a voltage of the second node N2 and provide the driving current to the light emitting element EL. Accordingly, the first transistor T1 may be called a driving transistor of the pixel circuit PXa.

The second transistor T2 may connect a data line DL and the first node N1 in response to a data write gate signal GW[N]. The data line DL may transfer a reference voltage VREF during certain time periods, and may transfer a data voltage VDATA during other time periods. The second transistor T2 may include a gate electrode receiving the data write gate signal GW[N], a first electrode connected to the data line DL, and a second electrode connected to the first node N1.

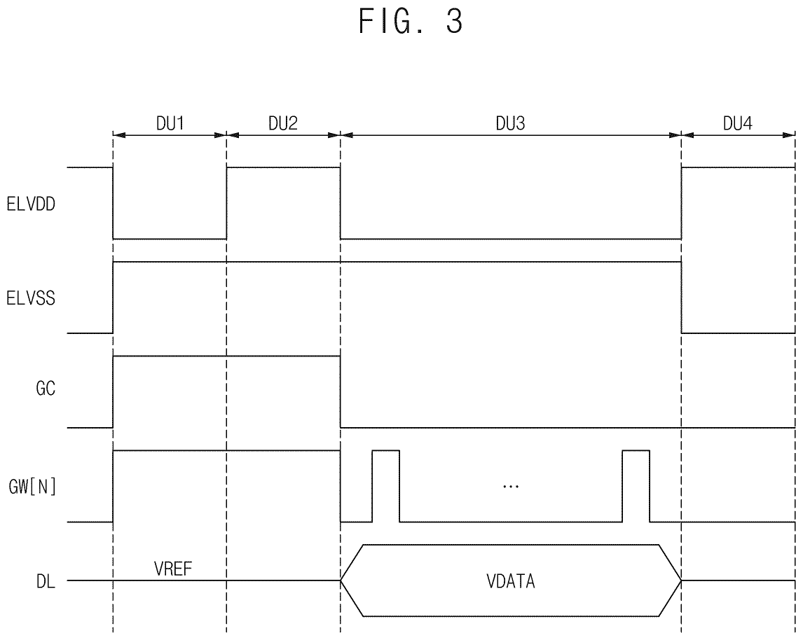

The third transistor T3 may provide the reference voltage VREF to the third node N3 in response to a “compensation gate signal” GC. The third transistor T3 may include a gate electrode receiving the compensation gate signal GC, a first electrode receiving the reference voltage VREF, and a second electrode connected to the third node N3. However, the present inventive concept is not limited thereto. In another embodiment, the reference voltage VREF received by the first electrode of the third transistor T3 may be different from the reference voltage VREF transferred by the data line DL. In either case, the compensation gate signal GC is herein called a compensation gate signal because, as will become apparent below, during a compensation period (DU2 of FIG. 3) the compensation gate signal GC is applied at a level sufficient to turn the third transistor T3 ON. This causes reference voltage VREF to be transferred to one end of second capacitor C2 and, in conjunction with the operation of the first transistor T1 to change the voltage at the second node N2, may enable the voltage across the first capacitor C1 to equal the threshold voltage of the first transistor T1 and thereby compensate the threshold voltage of the first transistor T1 (as explained more fully later).

The first capacitor C1 may include a first electrode connected to the first node N1 and a second electrode connected to the second node N2.

The second capacitor C2 may include a first electrode connected to the second node N2 and a second electrode connected to the third node N3.

As such, the pixel circuit PXa may have three transistors T1, T2, T3 and two capacitors C1, C2. Accordingly, the pixel circuit PXa may occupy a small area and allow for a high PPI in the display device 1.

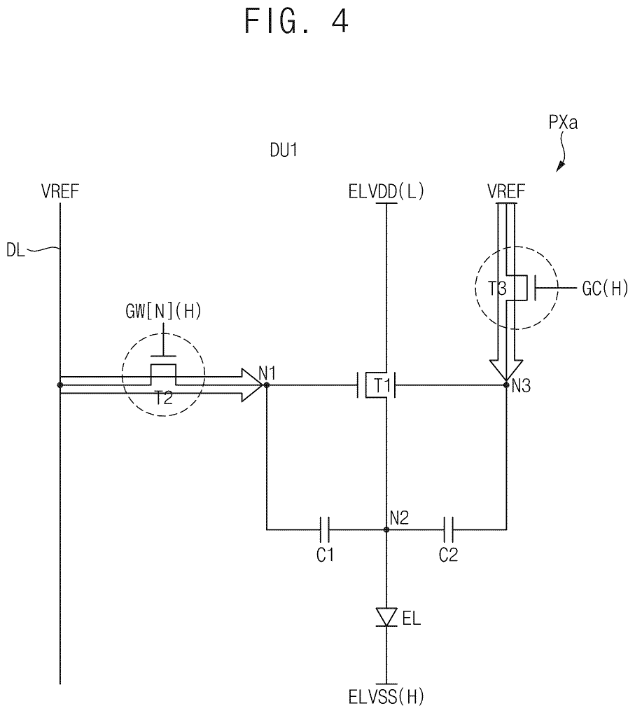

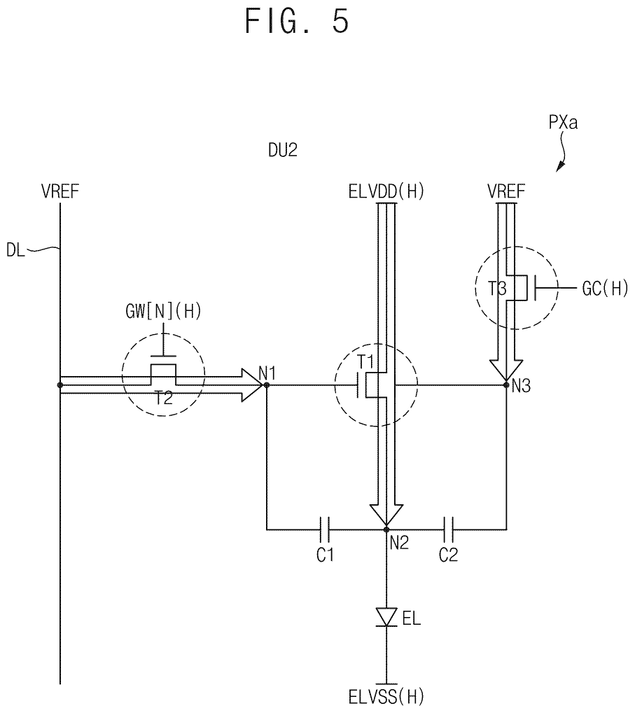

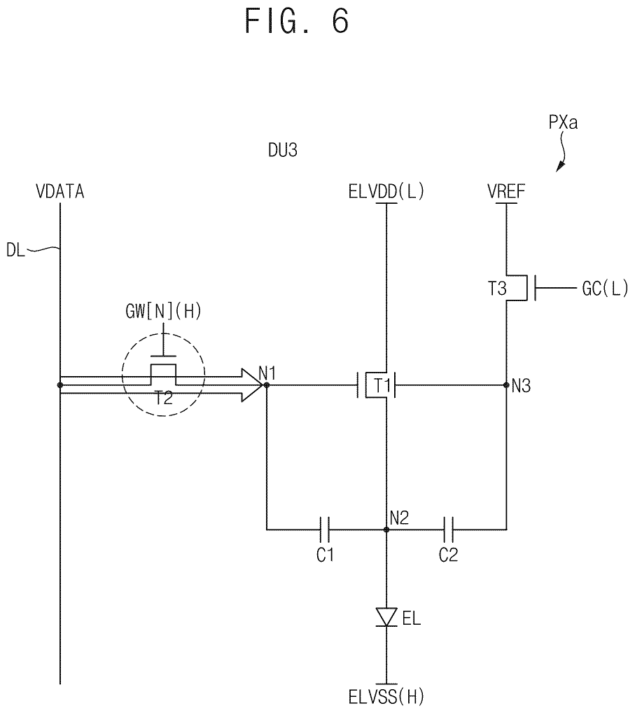

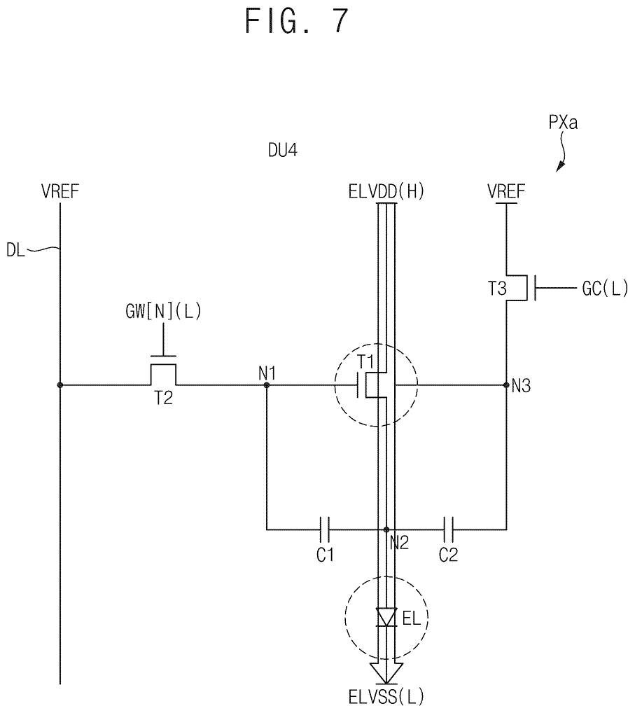

FIG. 3 is a timing diagram showing an example of operating a pixel circuit PXa of FIG. 2. FIG. 4 is a circuit diagram showing an example of operating a pixel circuit PXa of FIG. 2 in a first duration (interchangeably, “time period” or just “period”) DU1 of FIG. 3. FIG. 5 is a circuit diagram showing an example of operating a pixel circuit PXa of FIG. 2 in a second duration DU2 of FIG. 3. FIG. 6 is a circuit diagram showing an example of operating a pixel circuit PXa of FIG. 2 in a third duration DU3 of FIG. 3. FIG. 7 is a circuit diagram showing an example of operating a pixel circuit PXa of FIG. 2 in a fourth duration DU4 of FIG. 3.

In the embodiment of FIGS. 2-7, the first power supply voltage ELVDD may be at a high level “ELVDD(H)” during certain periods and at a low level “ELVDD(L)” during other periods. Further, the second power supply voltage ELVSS may be at a high level “ELVSS(H)” during certain periods and at a low level “ELVSS(L)” during other time periods. ELVDD(H) may be higher than each of ELVSS(H) and the reference voltage VREF. ELVDD(L) may be higher than ELVSS(L), and may be less than or equal to each of ELVSS(H) and the reference voltage VREF.

Referring to FIGS. 3 and 4, in a first duration DU1, the first power supply voltage ELVDD may have the low level L, the second power supply voltage ELVSS may have the high level H, the compensation gate signal GC may have the high level H, the data write gate signal GW[N] may have the high level H, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXa.

The second transistor T2 may be turned on in response to the data write gate signal GW[N] having the high level H to connect the data line DL transferring the reference voltage VREF to the first node N1. Therefore, the second transistor T2 may provide the reference voltage VREF to the first node N1, and a voltage of the first node N1 may have the reference voltage VREF.

The third transistor T3 may be turned on in response to the compensation gate signal GC having the high level H to provide the reference voltage VREF to the third node N3. Therefore, a voltage of the third node N3 may have the reference voltage VREF.

Since the voltage of the first node N1 has the reference voltage VREF, and the voltage of the third node N3 has the reference voltage VREF, a voltage of the second node N2 may have the reference voltage VREF, for the case in which the capacitance values of the first and second capacitors C1 and C2 are equal. This is because, when voltages are applied to the opposite sides of two capacitors C1, C2 connected in series, the voltage at the node between them may change proportionally to the capacitance values of the capacitors C1, C2. When the capacitance values are the same and the same voltage is applied to the opposite sides, the charge may be shared equally across both capacitors C1, C2, which results in the voltage at the node being equal to the applied voltage.

As such, since the voltage of the first node N1 and the voltage of the second node N2 are initialized to the reference voltage VREF in the first duration DU1, the first duration DU1 may be called an initialization period DU1.

Referring to FIG. 3 and FIG. 5, in a second duration DU2, the first power supply voltage ELVDD may have the high level H, the second power supply voltage ELVSS may have the high level H, the compensation gate signal GC may have the high level H, the data write gate signal GW[N] may have the high level H, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXa.

The second transistor T2 may be turned on in response to the data write gate signal GW[N] having the high level H to connect the data line DL transferring the reference voltage VREF to the first node N1. Therefore, the second transistor T2 may provide the reference voltage VREF to the first node N1, and a voltage of the first node N1 may have the reference voltage VREF.

The third transistor T3 may be turned on in response to the compensation gate signal GC having the high level H to provide the reference voltage VREF to the third node N3. Therefore, a voltage of the third node N3 may have the reference voltage VREF.

As the first power supply voltage ELVDD changes from the low level L to the high level H, the first transistor T1 may be turned on. Accordingly, the voltage of the second node N2 may be changed from the reference voltage VREF to a value (VREF−V_{TH1}) obtained by subtracting a threshold voltage V_{TH1} of the first transistor T1 from the reference voltage VREF. Accordingly, the first capacitor C1 and the second capacitor C2 may store the threshold voltage V_{TH1} of the first transistor T1 (since the voltage across the first capacitor C1 (from N1 to N2) and across the second capacitor C2 (from N3 to N2) is each (VREF−(VREF−V_{TH1}))=V_{TH1}) and “the threshold voltage V_{TH1} of the first transistor T1 may be compensated”. The latter phrase may be understood as follows: there may be variations in threshold voltage V_{TH1} among first transistors T1 from pixel circuit PXa to pixel circuit PXa within the display device 1. During the third duration DU3 discussed below, the first capacitor C1 may charge up to store a voltage having a value based on both the data voltage VDATA and threshold voltage V_{TH1}. This effectively removes potential visible artifacts due to the variations in threshold voltage V_{TH1} among the pixel circuits PXa (and compensates the threshold voltage V_{TH1} in each first transistor T1).

As such, since the threshold voltage V_{TH1} of the first transistor T1 is compensated in the second duration DU2, the second duration DU2 may be called a compensation period DU2.

Referring to FIG. 3 and FIG. 6, in a third duration DU3, the first power supply voltage ELVDD may have the low level L, the second power supply voltage ELVSS may have the high level H, the compensation gate signal GC may have the low level L, the data write gate signal GW[N] may have the high level H, and the data line DL may transfer the data voltage VDATA. The first power supply voltage ELVDD, the second power supply voltage ELVSS, and the compensation gate signal GC may be simultaneously applied to the pixel circuit PXa, and the data write gate signal GW[N] may be sequentially applied to the pixel circuit PXa.

The second transistor T2 may be turned on in response to the data write gate signal GW[N] having the high level H to connect the data line DL transferring the data voltage VDATA to the first node N1. Therefore, the second transistor T2 may provide the data voltage VDATA to the first node N1, and the voltage of the first node N1 may have the data voltage VDATA.

As such, since the data voltage VDATA is applied to the pixel circuit PXa in the third duration DU3, the third duration DU3 may be called a data write period DU3.

Referring to FIG. 3 and FIG. 7, in a fourth duration DU4, the first power supply voltage ELVDD may have the high level H, the second power supply voltage ELVSS may have the low level L, the compensation gate signal GC may have the low level L, the data write gate signal GW[N] may have the low level L, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXa.

Since the first power supply voltage ELVDD has the high level H and the second power supply voltage ELVSS has the low level L, the first transistor T1 may generate the driving current based on the voltage of the first node N1 and the voltage of the second node N2 and provide the driving current to the light emitting element EL. The light emitting element EL may emit a light based on the driving current. A luminance of the light emitting element EL may be determined based on an intensity of the driving current, and the intensity of the driving current may be determined based on the level of the data voltage VDATA. For example, the luminance of the light emitting element EL may be determined based on the level of the data voltage VDATA.

As such, since the light emitting element EL emits the light in the fourth duration DU4, the fourth duration DU4 may be called a light emitting period DU4.

FIG. 8 is a circuit diagram showing a pixel circuit PXb, which is an example of the pixel circuit PX of FIG. 1.

The pixel circuit PXb of FIG. 8 is similar to the pixel circuit PXa of FIG. 2, except for the connection arrangement of the first transistor T1. Therefore, the same reference numeral is used for the same or similar component, and a redundant description is omitted.

Referring to FIG. 1 and FIG. 8, the pixel circuit PXb may include a first transistor T1, a second transistor T2, a third transistor T3, a first capacitor C1, a second capacitor C2, and a light emitting element EL. In an embodiment, the first to third transistors T1 to T3 may be NMOS transistors. In another embodiment, the first transistor T1 may be the NMOS transistor, and the second to third transistors T2 to T3 may be PMOS transistors.

Any of the NMOS transistors may be turned on in response to a gate signal having a high level, and may be turned off in response to a gate signal having a low level. Any of the PMOS transistors may be turned on in response to a gate signal having a low level, and may be turned off in response to a gate signal having a high level.

The first transistor T1 may include a first gate electrode connected to a first node N1, a first electrode receiving a first power supply voltage ELVDD, a second electrode connected to a second node N2, and a second gate electrode connected to a third node N3. In an embodiment, the first gate electrode of the first transistor T1 may be a back gate electrode, and the second gate electrode of the first transistor T1 may be a gate electrode. The first transistor T1 may generate a driving current based on a voltage of the second node N2 and a voltage of the third node N3 and provide the driving current to the light emitting element EL.

The second transistor T2 may connect the data line DL and the first node N1 in response to a data write gate signal GW[N]. The data line DL may transfer a reference voltage VREF or a data voltage VDATA. The second transistor T2 may include a gate electrode receiving the data write gate signal GW[N], a first electrode connected to the data line DL, and a second electrode connected to the first node N1.

The third transistor T3 may provide the reference voltage VREF to the third node N3 in response to a compensation gate signal GC. The third transistor T3 may include a gate electrode receiving the compensation gate signal GC, a first electrode receiving the reference voltage VREF, and a second electrode connected to the third node N3. However, the present inventive concept is not limited thereto. In another embodiment, the reference voltage VREF received by the first electrode of the third transistor T3 may be different from the reference voltage VREF transferred by the data line DL.

The first capacitor C1 may include a first electrode connected to the first node N1 and a second electrode connected to the second node N2.

The second capacitor C2 may include a first electrode connected to the second node N2 and a second electrode connected to the third node N3.

The timing diagram of FIG. 3 may be equally applicable to the pixel circuit PXb. Accordingly, during the initialization period DU1, the voltage of the first node N1 and the voltage of the second node N2 may be initialized to the reference voltage VREF; during the compensation period DU2, a voltage across each of the capacitors C1 and C2 is formed equal to or slightly less than threshold voltage V_{TH1}; during the data write period DU3, data voltage VDATA may be applied to the pixel circuit PXb; and during the light emitting period DU4, the light emitting element EL emits light.

As such, the pixel circuit PXb may include three transistors T1, T2, T3 and two capacitors C1, C2. Accordingly, the pixel circuit PXb may occupy a small area and allow for a high PPI in the display device 1.

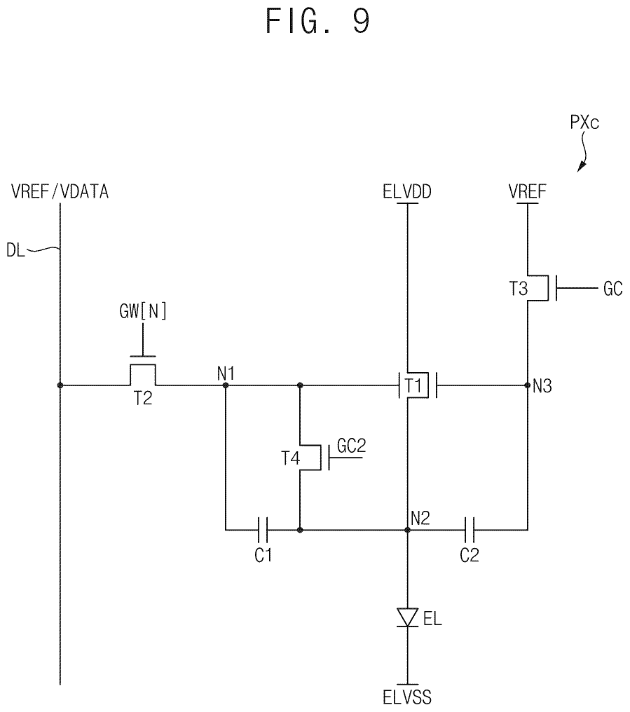

FIG. 9 is a circuit diagram showing a pixel circuit PXc, which is an example of the pixel circuit PX of FIG. 1.

The pixel circuit PXc of FIG. 9 is similar to the pixel circuit PXa of FIG. 2, but a fourth transistor T4 is added. Therefore, the same reference numeral is used for the same or similar component, and a redundant description is omitted.

Referring to FIG. 1 and FIG. 9, the pixel circuit PXc may include a first transistor T1, a second transistor T2, a third transistor T3, a fourth transistor T4, a first capacitor C1, a second capacitor C2, and a light emitting element EL. In an embodiment, the first to fourth transistors T1 to T4 may be NMOS transistors. In another embodiment, the first transistor T1 may be the NMOS transistor, and the second to fourth transistors T2 to T4 may be PMOS transistors.

Any of the NMOS transistors may be turned on in response to a gate signal having a high level, and may be turned off in response to a gate signal having a low level. Any of the PMOS transistors may be turned on in response to a gate signal having a low level, and may be turned off in response to a gate signal having a high level.

The first transistor T1 may include a second gate electrode connected to a first node N1, a first electrode receiving a first power supply voltage ELVDD, a second electrode connected to a second node N2, and a first gate electrode connected to a third node N3. As shown in FIG. 9, the first gate electrode of the first transistor T1 may be a gate electrode, and the second gate electrode of the first transistor T1 may be a back gate electrode. In other embodiments, the first gate electrode is a back gate electrode and the second gate electrode is a gate electrode. The first transistor T1 may generate a driving current based on a voltage of the second node N2 and a voltage of the third node N3 and provide the driving current to the light emitting element EL.

The second transistor T2 may connect a data line DL and the first node N1 in response to a data write gate signal GW[N]. The data line DL may transfer a reference voltage VREF or a data voltage VDATA. The second transistor T2 may include a gate electrode receiving the data write gate signal GW[N], a first electrode connected to the data line DL, and a second electrode connected to the first node N1.

The third transistor T3 may provide a reference voltage VREF to the third node N3 in response to a compensation gate signal GC. The third transistor T3 may include a gate electrode receiving the compensation gate signal GC, a first electrode receiving the reference voltage VREF, and a second electrode connected to the third node N3. However, the present inventive is not limited thereto. In another embodiment, the reference voltage VREF received by the first electrode of the third transistor T3 may be different from the reference voltage VREF transferred by the data line DL.

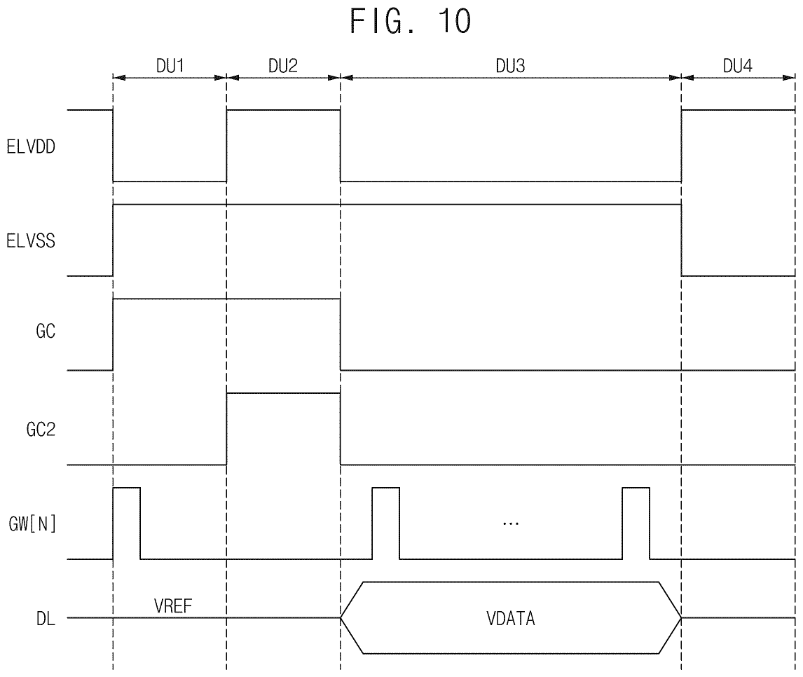

The fourth transistor T4 may connect the first node N1 and the second node N2 in response to the second compensation gate signal GC2 having an on-voltage (a high level for an NMOS). Therefore, the voltage of the first node N1 may be equal to the voltage of the second node N2 and cause the first transistor T1 to be diode-connected during a compensation period DU2, which may compensate the threshold voltage V_{TH1} of the first transistor T1 (explained further below in connection with FIGS. 10-14). The fourth transistor T4 may include a gate electrode receiving the second compensation gate signal GC2, a first electrode connected to the first node N1, and a second electrode connected to the second node N2.

The first capacitor C1 may include a first electrode connected to the first node N1 and a second electrode connected to the second node N2.

The second capacitor C2 may include a first electrode connected to the second node N2 and a second electrode connected to the third node N3.

As such, the pixel circuit PXc may include four transistors T1, T2, T3, T4 and two capacitors C1, C2. Accordingly, the pixel circuit PXc may occupy a small area and allow for a high PPI in the display device 1.

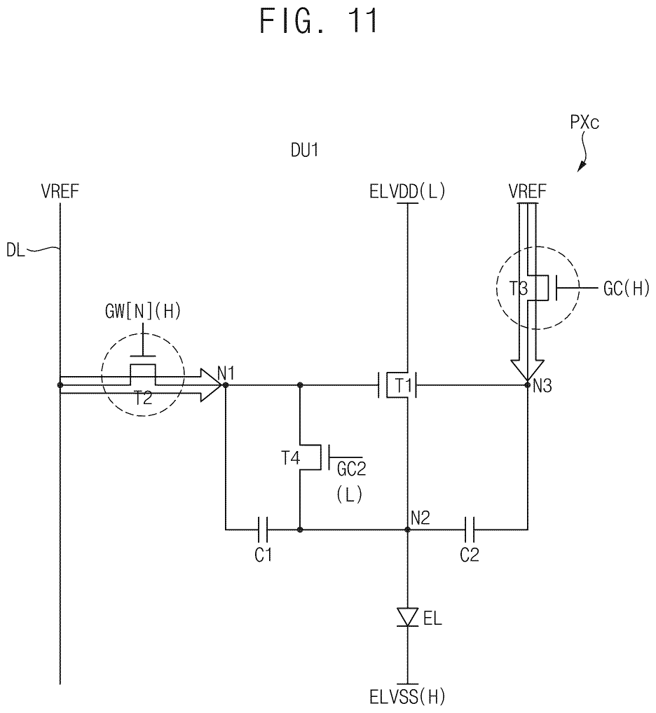

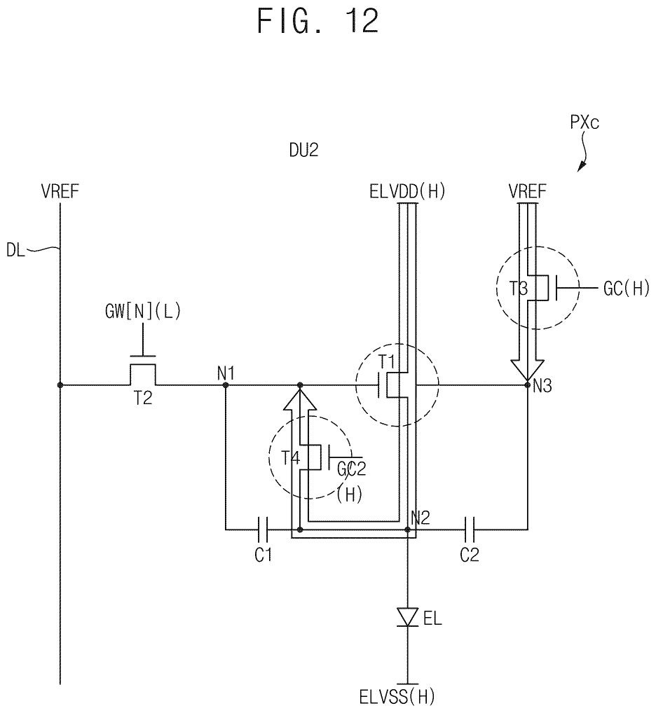

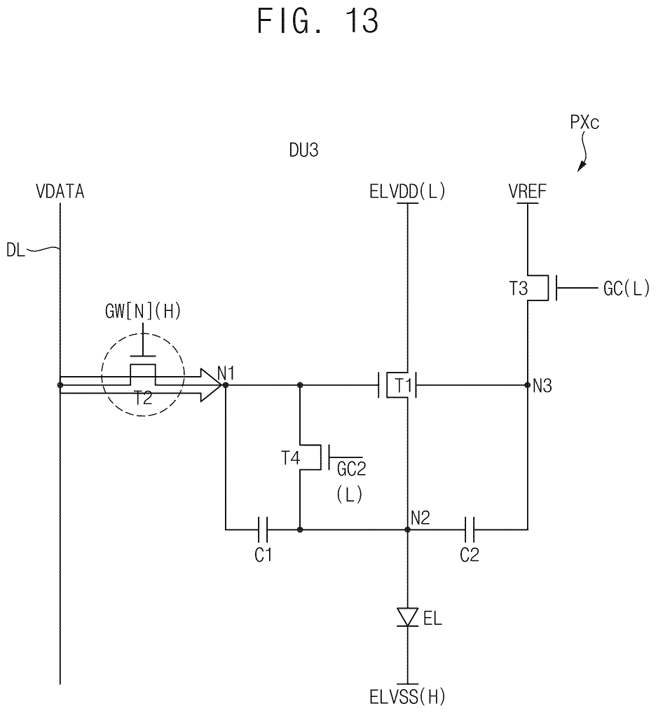

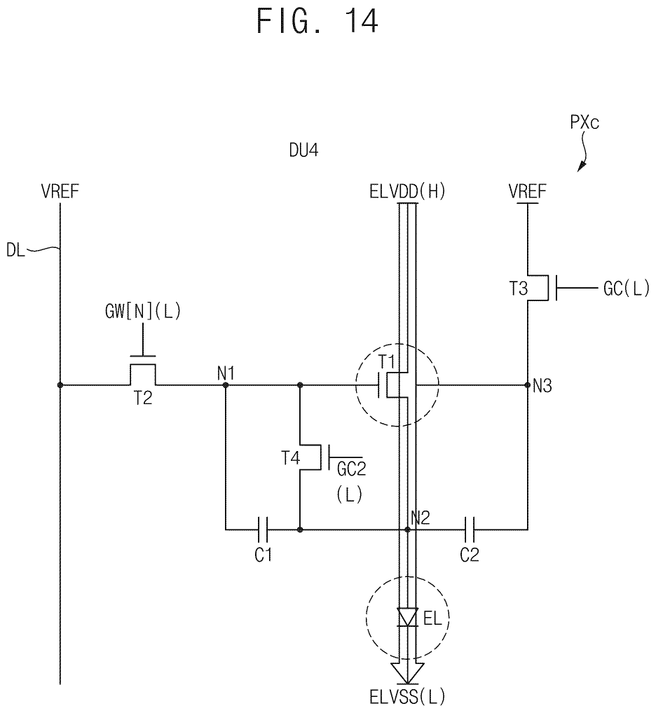

FIG. 10 is a timing diagram showing an example of operating a pixel circuit PXc of FIG. 9. FIG. 11 is a circuit diagram showing an example of operating a pixel circuit PXc of FIG. 9 in a first duration DU1 of FIG. 10. FIG. 12 is a circuit diagram showing an example of operating a pixel circuit PXc of FIG. 9 in a second duration DU2 of FIG. 10. FIG. 13 is a circuit diagram showing an example of operating a pixel circuit PXc of FIG. 9 in a third duration DU3 of FIG. 10. FIG. 14 is a circuit diagram showing an example of operating a pixel circuit PXc of FIG. 9 in a fourth duration DU4 of FIG. 10.

Referring to FIGS. 10 and 11, in a first duration DU1, the first power supply voltage ELVDD may have the low level L, the second power supply voltage ELVSS may have the high level H, the compensation gate signal GC may have the high level H, the second compensation gate signal GC2 may have the low level L, the data write gate signal GW[N] may have the high level H, and the data line DL may transfer the reference voltage VREF. The first power supply voltage ELVDD at a low level L, the second power supply voltage ELVSS at a high level H, the compensation gate signal GC at an on-voltage level, the second compensation gate signal GC2 at an off-voltage level, and the data write gate signal GW[N] may be simultaneously applied to the pixel circuit PXc. Note that the data write gate signal GW[N] is shown applied as a short pulse at the beginning of the first duration DU1 (less than one half of the first duration DU1), which differs from the signal diagram of FIG. 3 in which data write gate signal GW[N] is applied as an on-voltage throughout the first duration DU1. In other examples, data write gate signal GW[N] is applied to the pixel circuit PXc as a pulse having a duration longer than one half of the first duration DU1.

The second transistor T2 may be turned on during the short pulse of the data write gate signal GW[N] having the high level H to connect the data line DL transferring the reference voltage VREF to the first node N1. Therefore, the second transistor T2 may provide the reference voltage VREF to the first node N1, and a voltage of the first node N1 may have the reference voltage VREF.

The third transistor T3 may be turned on in response to the compensation gate signal GC having the high level H to provide the reference voltage VREF to the third node N3. Therefore, a voltage of the third node N3 may have the reference voltage VREF.

Since the voltage of the first node N1 has the reference voltage VREF and the voltage of the third node N3 has the reference voltage VREF, a voltage of the second node N2 may have the reference voltage VREF.

As such, since the voltage of the first node N1 and the voltage of the second node N2 are initialized to the reference voltage VREF in the first duration DU1, the first duration DU1 may be called an initialization period DU1.

Referring to FIG. 10 and FIG. 12, in a second duration DU2, the first power supply voltage ELVDD may have the high level H, the second power supply voltage ELVSS may have the high level H, the compensation gate signal GC may have the high level H, the second compensation gate signal GC2 may have the high level H, the data write gate signal GW[N] may have the low level L, and the data line DL may transfer the reference voltage VREF. The first power supply voltage ELVDD, the second power supply voltage ELVSS, the compensation gate signal GC, the second compensation gate signal GC2, and the data write gate signal GW[N] may be simultaneously applied to the pixel circuit PXc.

The third transistor T3 may be turned on in response to the compensation gate signal GC having the high level H to provide the reference voltage VREF to the third node N3. Therefore, a voltage of the third node N3 may have the reference voltage VREF.

As the first power supply voltage ELVDD changes from the low level L to the high level H and the fourth transistor T4 is turned on in response to the second compensation gate signal GC2 having the high level H, the first transistor T1 may be turned on. Accordingly, the first transistor T1 may be diode-connected, causing a threshold voltage V_{TH1} of the first transistor T1 to be compensated. This is because when first transistor T1 is diode-connected, a voltage drop equal to that of a diode operating in saturation may occur across the drain-to-source electrodes, and the voltage drop may equal the threshold voltage V_{TH1} of first transistor T1. Thus, the voltage at the second node N2 may change to a “pre-charge voltage” of (ELVDD(H)−V_{TH1}). During the third duration DU3 discussed below, the first capacitor C1 may charge up to store a voltage having a value based on both the applied data voltage VDATA and (ELVDD(H)−V_{TH1}), thereby effectively removing potential undesirable visible effects of the variations in threshold voltage V_{TH1} among the pixel circuits PXc (and compensating the threshold voltage V_{TH1} of first transistor T1).

As such, since the threshold voltage V_{TH1} of the first transistor T1 is compensated in the second duration DU2, the second duration DU2 may be called a compensation period DU2.

Referring to FIG. 10 and FIG. 13, in a third duration DU3, the first power supply voltage ELVDD may have the low level L, the second power supply voltage ELVSS may have the high level H, the compensation gate signal GC may have the low level L, the second compensation gate signal GC2 may have the low level L, the data write gate signal GW[N] may have the high level H, and the data line DL may transfer the data voltage VDATA. The first power supply voltage ELVDD, the second power supply voltage ELVSS, the compensation gate signal GC, and the second compensation gate signal GC2 may be simultaneously applied to the pixel circuit PXc, and the data write gate signal GW[N] may be sequentially applied, in a sequence of pulses, to the pixel circuit PXc.

The second transistor T2 may be turned on in response to the data write gate signal GW[N] having the high level H to connect the data line DL transferring the data voltage VDATA to the first node N1. Therefore, the second transistor T2 may provide the data voltage VDATA to the first node N1, and a voltage of the first node N1 may have the data voltage VDATA. The first capacitor C1 may charge up with a voltage across its terminals based on the data voltage VDATA and the pre-charge voltage. The pulsing of the data write gate signal GW[N] during this period, as shown in FIG. 10, may facilitate the charging up of the first capacitor C1.

As such, since the data voltage VDATA is applied to the pixel circuit PXc in the third duration DU3, the third duration DU3 may be called a data write period DU3.

Referring to FIG. 10 and FIG. 14, in a fourth duration DU4, the first power supply voltage ELVDD may have the high level H, the second power supply voltage ELVSS may have the low level L, the compensation gate signal GC may have the low level L, the second compensation gate signal GC2 may have the low level L, the data write gate signal GW[N] may have the low level L, and the data line DL may transfer the reference voltage VREF. The first power supply voltage ELVDD, the second power supply voltage ELVSS, the compensation gate signal GC, the second compensation gate signal GC2 (at an off-voltage level), and the data write gate signal GW[N] (at an off-voltage level) may be simultaneously applied to the pixel circuit PXc.

Since the first power supply voltage ELVDD has the high level H and the second power supply voltage ELVSS has the low level L, the first transistor T1 may generate the driving current based on the voltage of the first node N1 and the voltage of the second node N2 (in other words, based on the voltage stored by the first capacitor C1, which is the gate-to-source voltage of first transistor T1 during fourth duration DU4) and provide the driving current to the light emitting element EL. The light emitting element EL may emit light based on the driving current. A luminance of the light emitting element EL may be determined based on an intensity of the driving current, and the intensity of the driving current may be determined based on a level of the data voltage VDATA, with the effects of threshold voltage V_{TH1} variations removed. For example, the luminance of the light emitting element EL may be determined based on the level of the data voltage VDATA.

As such, since the light emitting element EL emits the light in the fourth duration DU4, the fourth duration DU4 may be called a light emitting period DU4.

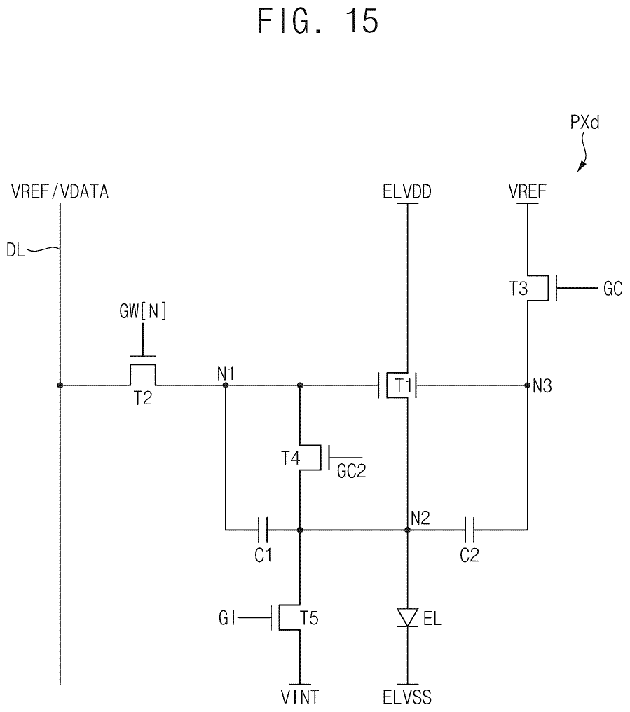

FIG. 15 is a circuit diagram showing a pixel circuit PXd, which is an example of the pixel circuit PX of FIG. 1.

The pixel circuit PXd of FIG. 15 is similar to the pixel circuit PXc of FIG. 9, but adds a fifth transistor T5. Therefore, the same reference numeral is used for the same or similar component, and a redundant description is omitted.

Referring to FIG. 1 and FIG. 15, the pixel circuit PXd may include a first transistor T1, a second transistor T2, a third transistor T3, a fourth transistor T4, a fifth transistor T5, a first capacitor C1, a second capacitor C2, and a light emitting element EL. In an embodiment, the first to fifth transistors T1 to T5 may be NMOS transistors. In another embodiment, the first transistor T1 may be the NMOS transistor, and the second to fifth transistors T2 to T5 may be PMOS transistors.

Any of the NMOS transistors may be turned on in response to a gate signal having a high level, and may be turned off in response to a gate signal having a low level. Any of the PMOS transistors may be turned on in response to a gate signal having a low level, and may be turned off in response to a gate signal having a high level.

The first transistor T1 may include a first gate electrode connected to a first node N1, a first electrode receiving a first power supply voltage ELVDD, a second electrode connected to a second node N2, and a second gate electrode connected to a third node N3. In an embodiment, the first gate electrode of the first transistor T1 may be a gate electrode, and the second gate electrode of the first transistor T1 may be a back gate electrode. The first transistor T1 may generate a driving current based on a voltage of the first node N1 and a voltage of the second node N2 and provide the driving current to the light emitting element EL.

The second transistor T2 may connect a data line DL and the first node N1 in response to a data write gate signal GW[N]. The data line DL may transfer a reference voltage VREF or a data voltage VDATA. The second transistor T2 may include a gate electrode receiving the data write gate signal GW[N], a first electrode connected to the data line DL, and a second electrode connected to the first node N1.

The third transistor T3 may provide the reference voltage VREF to the third node N3 in response to a compensation gate signal GC. The third transistor T3 may include a gate electrode receiving the compensation gate signal GC, a first electrode receiving the reference voltage VREF, and a second electrode connected to the third node N3. However, the present inventive concept is not limited thereto. In another embodiment, the reference voltage VREF received by the first electrode of the third transistor T3 may be different from the reference voltage VREF transferred by the data line DL.

The fourth transistor T4 may connect the first node N1 and the second node N2 in response to the second compensation gate signal GC2. Therefore, the voltage of the first node N1 may be equal to the voltage of the second node N2. The fourth transistor T4 may include a gate electrode receiving the second compensation gate signal GC2, a first electrode connected to the first node N1, and a second electrode connected to the second node N2.

The fifth transistor T5 may provide an initialization voltage VINT to the second node N2 in response to an initialization gate signal GI. Therefore, the voltage of the second node N2 may be initialized to the initialization voltage VINT. The fifth transistor T5 may include a gate electrode receiving the initialization gate signal GI, a first electrode receiving the initialization voltage VINT, and a second electrode connected to the second node N2.

The first capacitor C1 may include a first electrode connected to the first node N1 and a second electrode connected to the second node N2.

The second capacitor C2 may include a first electrode connected to the second node N2 and a second electrode connected to the third node N3.

As such, the pixel circuit PXd may include five transistors T1, T2, T3, T4, T5 and two capacitors C1, C2. Accordingly, the pixel circuit PXd may have a small area and allow for a high PPI in the display device 1.

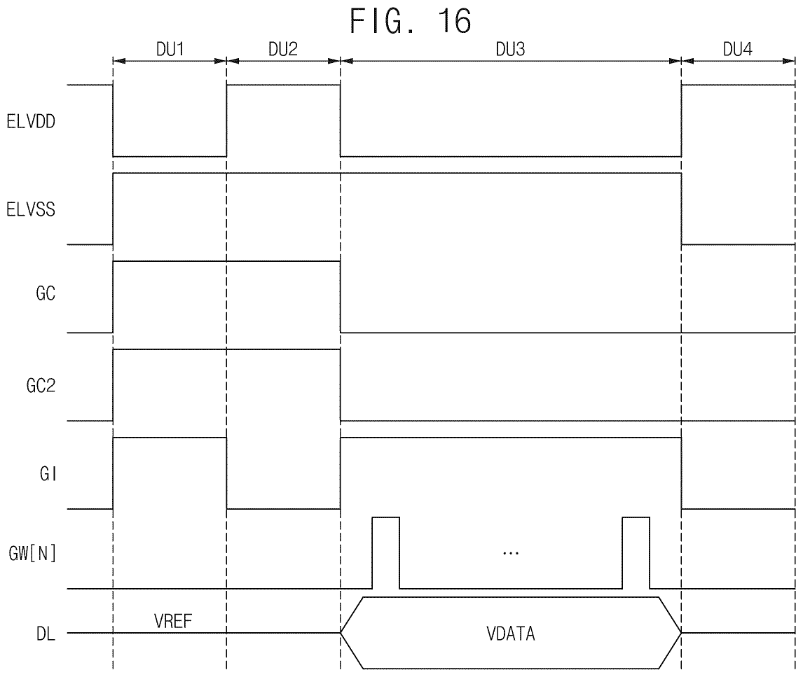

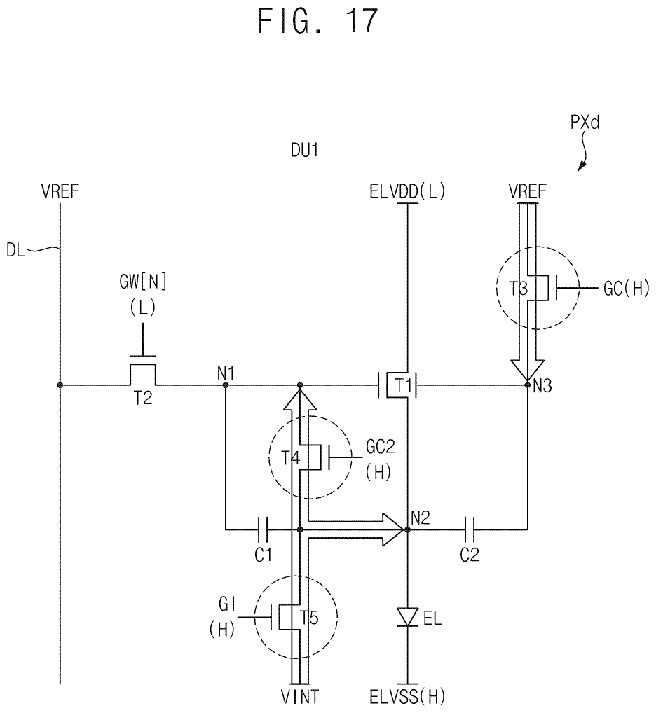

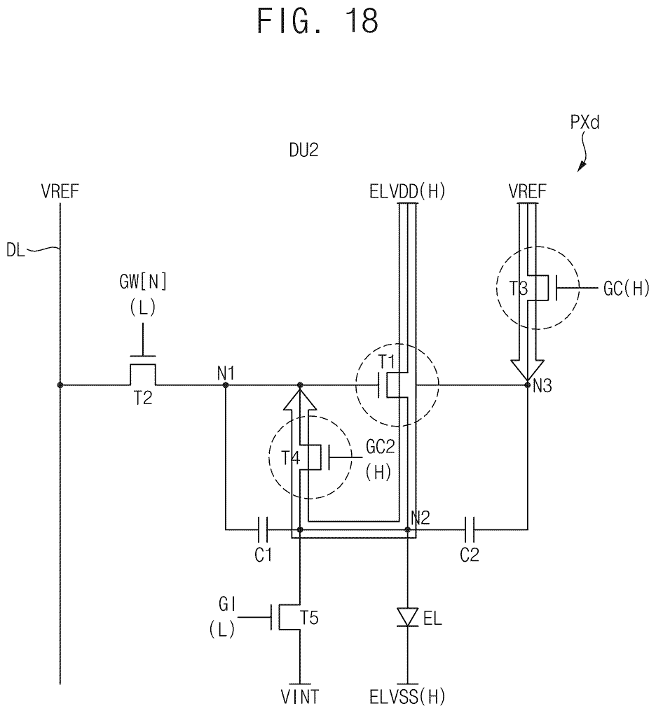

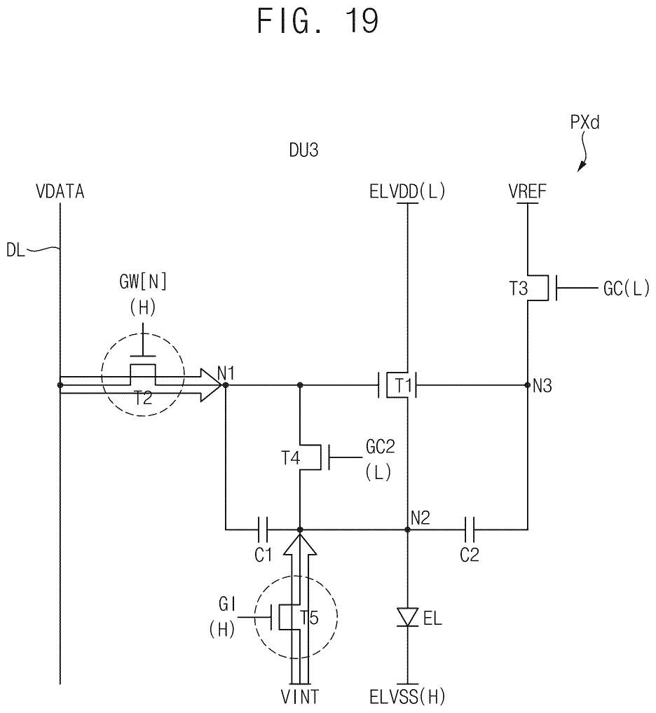

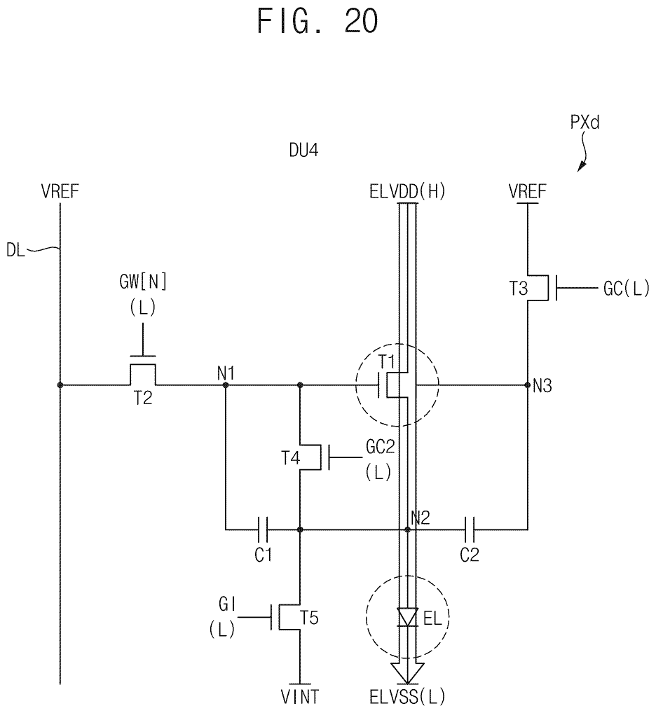

FIG. 16 is a timing diagram showing an example of operating a pixel circuit PXd of FIG. 15. FIG. 17 is a circuit diagram showing an example of operating a pixel circuit PXd of FIG. 15 in a first duration DU1 of FIG. 16. FIG. 18 is a circuit diagram showing an example of operating a pixel circuit PXd of FIG. 15 in a second duration DU2 of FIG. 16. FIG. 19 is a circuit diagram showing an example of operating a pixel circuit PXd of FIG. 15 in a third duration DU3 of FIG. 16. FIG. 20 is a circuit diagram showing an example of operating a pixel circuit PXd of FIG. 15 in a fourth duration DU4 of FIG. 16.

Referring to FIGS. 16 and 17, in a first duration DU1, the first power supply voltage ELVDD may have the low level L, the second power supply voltage ELVSS may have the high level H, the compensation gate signal GC may have the high level H, the second compensation gate signal GC2 may have the high level H, the initialization gate signal GI may have the high level H, the data write gate signal GW[N] may have the low level L, and the data line DL may transfer the reference voltage VREF. The first power supply voltage ELVDD, the second power supply voltage ELVSS, the compensation gate signal GC, the second compensation gate signal GC2, the initialization gate signal GI, and the data write gate signal GW[N] may be simultaneously applied to the pixel circuit PXd.

The fifth transistor T5 may be turned on in response to the initialization gate signal GI having the high level H to provide the initialization voltage VINT to the second node N2. Therefore, a voltage of the second node N2 may have the initialization voltage VINT.

The fourth transistor T4 may be turned on in response to the second compensation gate signal GC2 having the high level H to provide the voltage of the second node N2 to the first node N1. Therefore, a voltage of the first node N1 may have the initialization voltage VINT.

As such, since the voltage of the first node N1 and the voltage of the second node N2 are initialized to the initialization voltage VINT in the first duration DU1, the first duration DU1 may be called an initialization period DU1.

Referring to FIG. 16 and FIG. 18, in a second duration DU2, the first power supply voltage ELVDD may have the high level H, the second power supply voltage ELVSS may have the high level H, the compensation gate signal GC may have the high level H, the second compensation gate signal GC2 may have the high level H, the initialization gate signal GI may have the low level L, the data write gate signal GW[N] may have the low level L, and the data line DL may transfer the reference voltage VREF. The first power supply voltage ELVDD, the second power supply voltage ELVSS, the compensation gate signal GC, the second compensation gate signal GC2, the initialization gate signal GI, and the data write gate signal GW[N] may be simultaneously applied to the pixel circuit PXd.

The third transistor T3 may be turned on in response to the compensation gate signal GC having the high level H to provide the reference voltage VREF to the third node N3. Therefore, a voltage of the third node N3 may have the reference voltage VREF.

As the first power supply voltage ELVDD changes from the low level L to the high level H and the fourth transistor T4 is turned on in response to the second compensation gate signal GC2 having the high level H, the first transistor T1 may be turned on.

As such, since the threshold voltage V_{TH1} of the first transistor T1 is compensated in the second duration DU2, the second duration DU2 may be called a compensation period DU2.

Referring to FIG. 16 and FIG. 19, in the third duration DU3, the first power supply voltage ELVDD may have the low level L, the second power supply voltage ELVSS may have the high level H, the compensation gate signal GC may have the low level L, the second compensation gate signal GC2 may have the low level L, the initialization gate signal GI may have the high level H, the data write gate signal GW[N] may have the high level H, and the data line DL may transfer the data voltage VDATA. The first power supply voltage ELVDD, the second power supply voltage ELVSS, the compensation gate signal GC, the second compensation gate signal GC2, and the initialization gate signal GI may be simultaneously applied to the pixel circuit PXd, and the data write gate signal GW[N] may be sequentially applied to the pixel circuit PXd.

The second transistor T2 may be turned on in response to the data write gate signal GW[N] having the high level H to connect the data line DL transferring the data voltage VDATA to the first node N1. Therefore, the second transistor T2 may provide the data voltage VDATA to the first node N1, and the voltage of the first node N1 may have the data voltage VDATA.

The fifth transistor T5 may be turned on in response to the initialization gate signal GI having the high level H to provide the initialization voltage VINT to the second node N2. Therefore, the voltage of the second node N2 may have the initialization voltage VINT.

As such, since the data voltage VDATA is applied to the pixel circuit PXd in the third duration DU3, the third duration DU3 may be called a data write period DU3.

Referring to FIG. 16 and FIG. 20, in a fourth duration DU4, the first power supply voltage ELVDD may have the high level H, the second power supply voltage ELVSS may have the low level L, the compensation gate signal GC may have the low level L, the second compensation gate signal GC2 may have the low level L, the initialization gate signal GI may have the low level L, the data write gate signal GW[N] may have the low level L, and the data line DL may transfer the reference voltage VREF. The first power supply voltage ELVDD, the second power supply voltage ELVSS, the compensation gate signal GC, the second compensation gate signal GC2, the initialization gate signal GI, and the data write gate signal GW[N] may be simultaneously applied to the pixel circuit PXd.

Since the first power supply voltage ELVDD has the high level H and the second power supply voltage ELVSS has the low level L, the first transistor T1 may generate a driving current based on a voltage of the first node N1 and a voltage of the second node N2 and provide the driving current to the light emitting element EL. The light emitting element EL may emit a light based on the driving current. A luminance of the light emitting element EL may be determined based on an intensity of the driving current, and the intensity of the driving current may be determined based on a level of the data voltage VDATA. For example, the luminance of the light emitting element EL may be determined based on the level of the data voltage VDATA.

As such, since the light emitting element EL emits the light in the fourth duration DU4, the fourth duration DU4 may be called a light emitting period DU4.

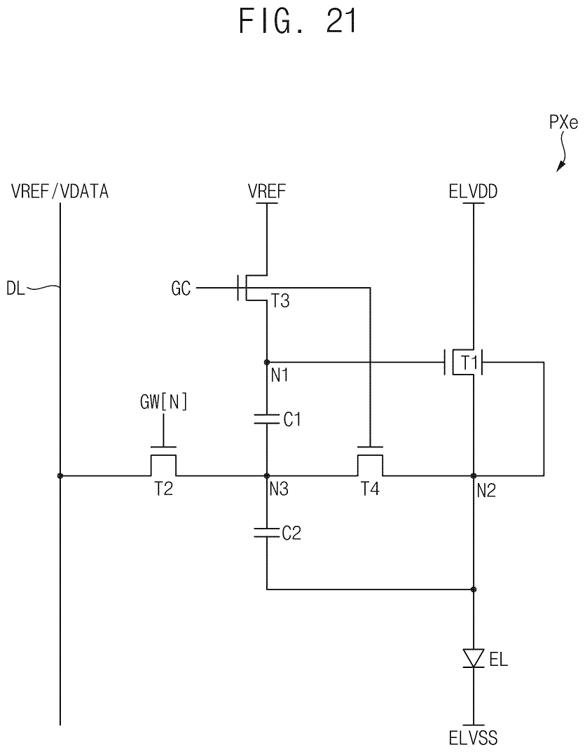

FIG. 21 is a circuit diagram showing a pixel circuit PXe, which is an example of the pixel circuit PX of FIG. 1.

Referring to FIG. 1 and FIG. 21, the pixel circuit PXe may include a first transistor T1, a second transistor T2, a third transistor T3, a fourth transistor T4, a first capacitor C1, a second capacitor C2, and a light emitting element EL. In an embodiment, the first to fourth transistors T1 to T4 may be NMOS transistors. In another embodiment, the first transistor T1 may be the NMOS transistor, and the second to fourth transistors T2 to T4 may be PMOS transistors.

Any of the NMOS transistors may be turned on in response to a gate signal having a high level, and may be turned off in response to a gate signal having a low level. Any of the PMOS transistors may be turned on in response to a gate signal having a low level, and may be turned off in response to a gate signal having a high level.

The first transistor T1 may include a first gate electrode connected to a first node N1, a first electrode receiving a first power supply voltage ELVDD, a second electrode connected to a second node N2, and a second gate electrode connected to the second node N2. In an embodiment, the first gate electrode of the first transistor T1 may be a gate electrode, and the second gate electrode of the first transistor T1 may be a back gate electrode. The first transistor T1 may generate a driving current based on a voltage of the first node N1 and a voltage of the second node N2 and provide the driving current to the light emitting element EL.

The second transistor T2 may connect a data line DL and a third node N3 in response to a data write gate signal GW[N]. The data line DL may transfer a reference voltage VREF or a data voltage VDATA. The second transistor T2 may include a gate electrode receiving the data write gate signal GW[N], a first electrode connected to the data line DL, and a second electrode connected to the third node N3.

The third transistor T3 may provide the reference voltage VREF to the first node N1 in response to a compensation gate signal GC. The third transistor T3 may include a gate electrode receiving the compensation gate signal GC, a first electrode receiving the reference voltage VREF, and a second electrode connected to the first node N1. However, the present inventive concept is not limited thereto. In another embodiment, the reference voltage VREF received by the first electrode of the third transistor T3 may be different from the reference voltage VREF transferred by the data line DL.

The fourth transistor T4 may connect the second node N2 and the third node N3 in response to the compensation gate signal GC. The fourth transistor T4 may include a gate electrode receiving the compensation gate signal GC, a first electrode connected to the second node N2, and a second electrode connected to the third node N3.

The first capacitor C1 may include a first electrode connected to the first node N1 and a second electrode connected to the third node N3.

The second capacitor C2 may include a first electrode connected to the second node N2 and a second electrode connected to the third node N3.

As such, the pixel circuit PXe may include four transistors T1, T2, T3, T4 and two capacitors C1, C2. Accordingly, the pixel circuit PXe may have a small area and allow for a high PPI in the display device 1.

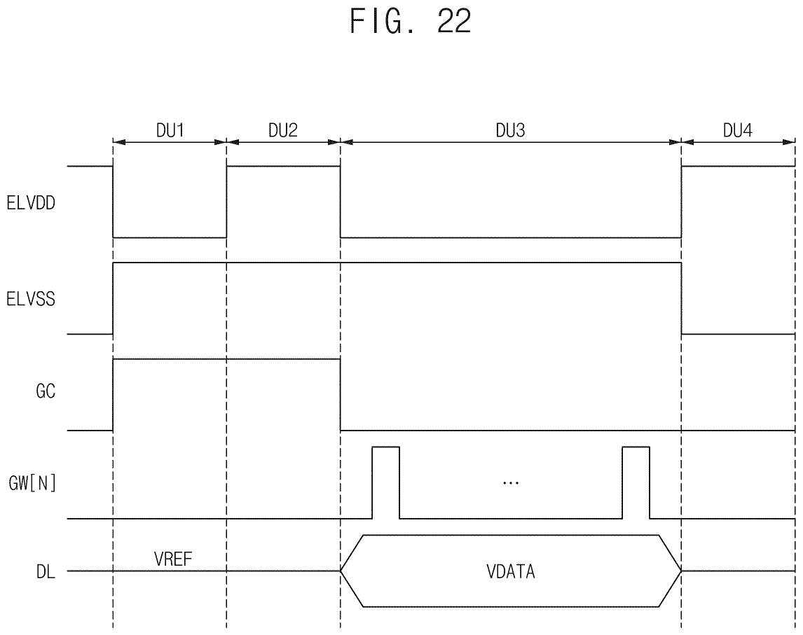

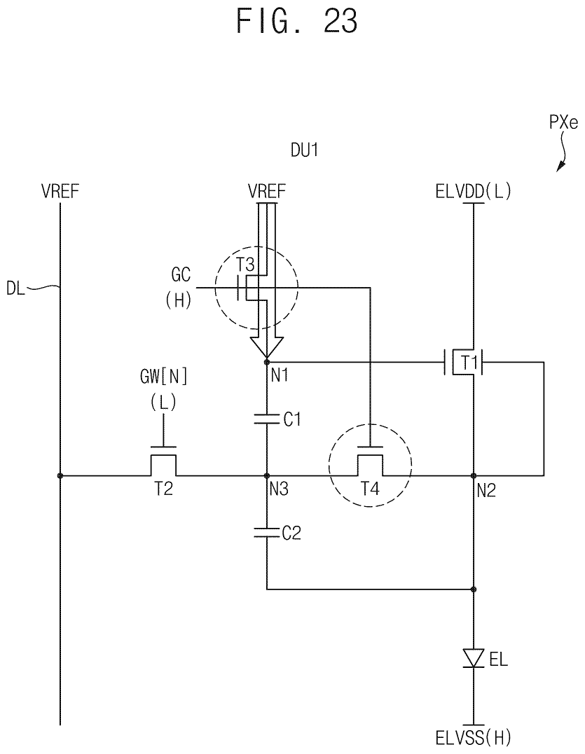

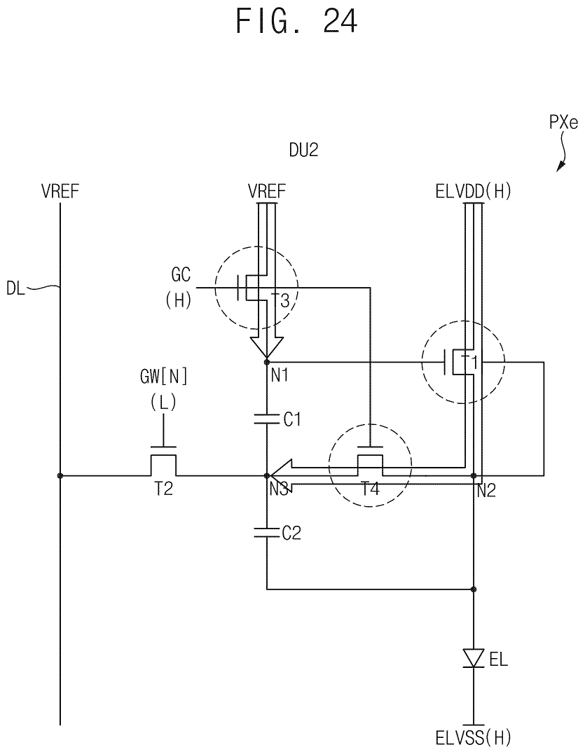

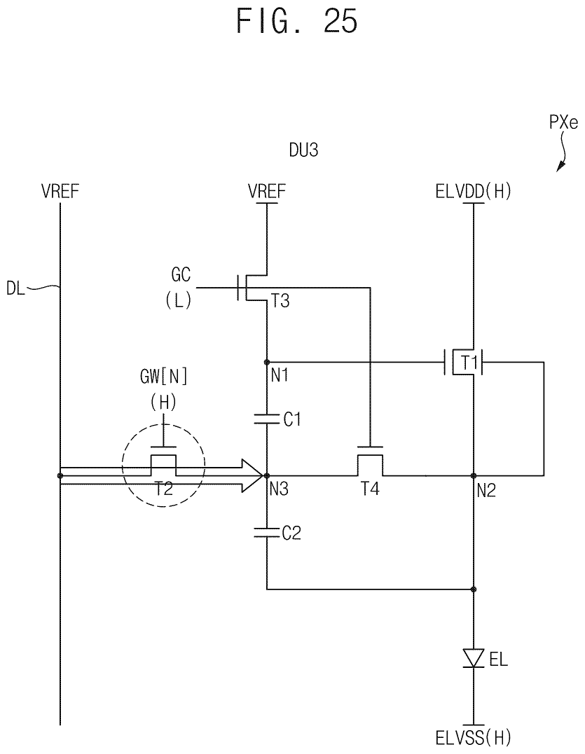

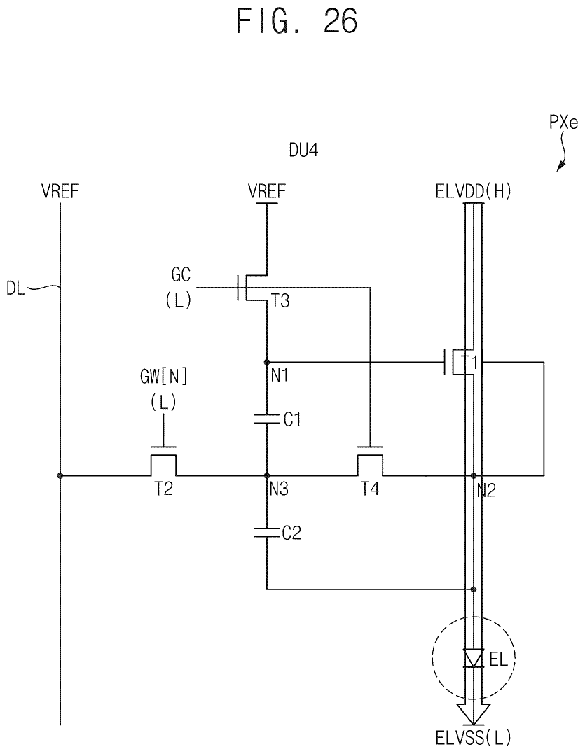

FIG. 22 is a timing diagram showing an example of operating a pixel circuit PXe of FIG. 21. FIG. 23 is a circuit diagram showing an example of operating a pixel circuit PXe of FIG. 21 in a first duration DU1 of FIG. 22. FIG. 24 is a circuit diagram showing an example of operating a pixel circuit PXe of FIG. 21 in a second duration DU2 of FIG. 22. FIG. 25 is a circuit diagram showing an example of operating a pixel circuit PXe of FIG. 21 in a third duration DU3 of FIG. 22. FIG. 26 is a circuit diagram showing an example of operating a pixel circuit PXe of FIG. 21 in a fourth duration DU4 of FIG. 22.

Referring to FIG. 22 and FIG. 23, in a first duration DU1, the first power supply voltage ELVDD may have the low level L, the second power supply voltage ELVSS may have the high level H, the compensation gate signal GC may have the high level H, the data write gate signal GW[N] may have the low level L, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXe.

The third transistor T3 may be turned on in response to the compensation gate signal GC having the high level H to provide the reference voltage VREF to the first node N1. Therefore, a voltage of the first node N1 may have the reference voltage VREF.

The fourth transistor T4 may be turned on in response to the compensation gate signal GC having the high level H.

As such, since the voltage of the first node N1 is initialized to the reference voltage VREF in the first duration DU1, the first duration DU1 may be called an initialization period DU1.

Referring to FIG. 22 and FIG. 24, in a second duration DU2, the first power supply voltage ELVDD may have the high level H, the second power supply voltage ELVSS may have the high level H, the compensation gate signal GC may have the high level H, the data write gate signal GW[N] may have the low level L, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXe.

The third transistor T3 may be turned on in response to the compensation gate signal GC having the high level H to provide the reference voltage VREF to the first node N1. Therefore, the voltage of the first node N1 may have the reference voltage VREF.

As the first power supply voltage ELVDD changes from the low level L to the high level H and the fourth transistor T4 is turned on in response to the compensation gate signal GC having the high level H, the first transistor T1 may be turned on. Accordingly, the voltage of the third node N3 may be changed to a value obtained by subtracting a threshold voltage V_{TH1} of the first transistor T1 from the reference voltage VREF. Accordingly, the first capacitor C1 may store the threshold voltage V_{TH1} of the first transistor T1, and the threshold voltage V_{TH1} of the first transistor T1 may be compensated.

As such, since the threshold voltage V_{TH1} of the first transistor T1 is compensated in the second duration DU2, the second duration DU2 may be called a compensation period DU2.

Referring to FIG. 22 and FIG. 25, in a third duration DU3, the first power supply voltage ELVDD may have the low level L, the second power supply voltage ELVSS may have the high level H, the compensation gate signal GC may have the low level L, the data write gate signal GW[N] may have the high level H, and the data line DL may transfer the data voltage VDATA. The first power supply voltage ELVDD, the second power supply voltage ELVSS, and the compensation gate signal GC may be simultaneously applied to the pixel circuit PXe, and the data write gate signal GW[N] may be sequentially applied to the pixel circuit PXe.

The second transistor T2 may be turned on in response to the data write gate signal GW[N] having the high level H to connect the data line DL transferring the data voltage VDATA to the third node N3. Therefore, the second transistor T2 may provide the data voltage VDATA to the third node N3, and the voltage of the third node N3 may have the data voltage VDATA.

As such, since the data voltage VDATA is applied to the pixel circuit PXe in the third duration DU3, the third duration DU3 may be called a data write period DU3.

Referring to FIG. 22 and FIG. 26, in a fourth duration DU4, the first power supply voltage ELVDD may have the high level H, the second power supply voltage ELVSS may have the low level L, the compensation gate signal GC may have the low level L, the data write gate signal GW[N] may have the low level L, and the data line DL may transfer the reference voltage VREF. The first power supply voltage ELVDD, the second power supply voltage ELVSS, the compensation gate signal GC, and the data write gate signal GW[N] may be simultaneously applied to the pixel circuit PXe.

Since the first power supply voltage ELVDD has the high level H and the second power supply voltage ELVSS has the low level L, the first transistor T1 may generate the driving current based on the voltage of the first node N1 and the voltage of the second node N2 and provide the driving current to the light emitting element EL. The light emitting element EL may emit light based on the driving current. A luminance of the light emitting element EL may be determined based on an intensity of the driving current, and the intensity of the driving current may be determined based on a level of the data voltage VDATA. For example, the luminance of the light emitting element EL may be determined based on the level of the data voltage VDATA.

As such, since the light emitting element EL emits the light in the fourth duration DU4, the fourth duration DU4 may be called a light emitting period DU4.

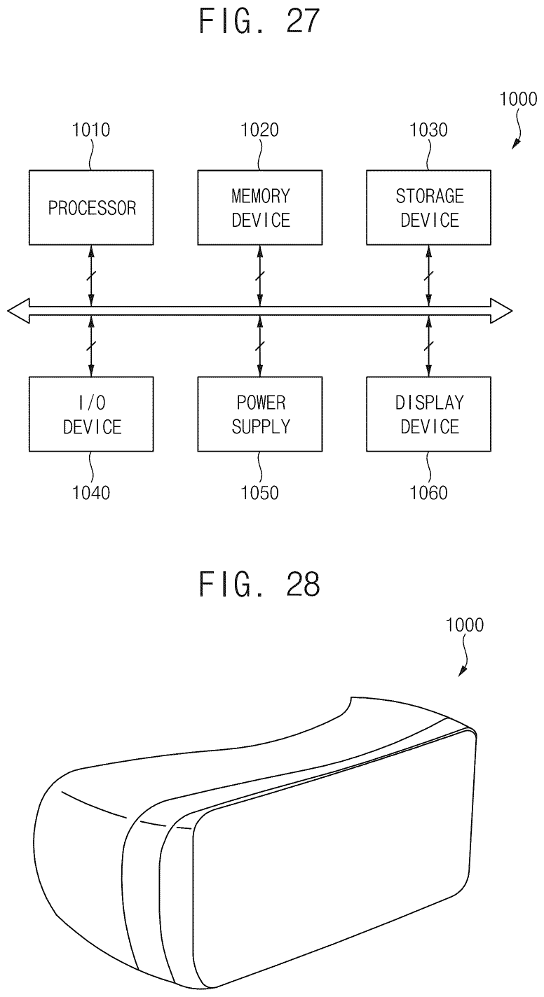

FIG. 27 is a block diagram showing an electronic device 1000 according to embodiments of the present inventive concept. FIG. 28 is a diagram showing an example in which an electronic device 1000 of FIG. 27 is implemented as a VR device.

Referring to FIGS. 1 to 26, an electronic device 1000 may include a processor 1010, a memory device 1020, a storage device 1030, an input/output (I/O) device 1040, a power supply 1050, and a display device 1060. The display device 1060 may be a display device 1 of FIG. 1. In addition, the electronic device 1000 may further include several ports which communicate with a video card, a sound card, a memory card, a USB device, etc., or communicate with other systems.

In an embodiment, as shown in FIG. 28, the electronic device 1000 may be implemented as a VR device. However, this is an example, and the electronic device 1000 is not limited thereto. For example, the electronic device 1000 may be implemented as a mobile phone, a video phone, a smart pad, a smart watch, a tablet PC, a vehicle navigation system, a computer monitor, a notebook, a head-mounted display device, etc.

The processor 1010 may perform specific calculations or tasks. In an embodiment, the processor 1010 may be a microprocessor, a central processing unit, an application processor, etc. The processor 1010 may be connected to other components through an address bus, a control bus, a data bus, etc. In an embodiment, the processor 1010 may also be connected to an expansion bus such as a Peripheral Component Interconnect (PCI) bus.

The processor 1010 may output input image data IMG and an input control signal CONT to a driving controller 200 of FIG. 1.

The memory device 1020 may store data necessary for an operation of the electronic device 1000. For example, the memory device 1020 may include a nonvolatile memory device such as an Erasable Programmable Read-Only Memory (EPROM) device, an Electrically Erasable Programmable Read-Only Memory (EEPROM) device, a flash memory device, a Phase Change Random Access Memory (PRAM) device, a Resistance Random Access Memory (RRAM) device, a Nano Floating Gate Memory NFGM) device, a Polymer Random Access Memory (PoRAM) device, a Magnetic Random Access Memory (MRAM) device, a Ferroelectric Random Access Memory (FRAM) device, and the like, and/or a volatile memory device such as a Dynamic Random Access Memory (DRAM) device, a Static Random Access Memory (SRAM) device, a mobile DRAM device, and the like.

The storage device 1030 may include a Solid State Drive (SSD), a Hard Disk Drive (HDD), a CD-ROM, etc. The input/output device 1040 may include input means such as a keyboard, a keypad, a touchpad, a touchscreen, a mouse, etc., and output means such as a speaker, a printer, etc. In an embodiment, the display device 1060 may be included in the input/output device 1040. The power supply 1050 may supply power necessary for the operation of the electronic device 1000. The display device 1060 may be connected to other components through the buses or other communication links.

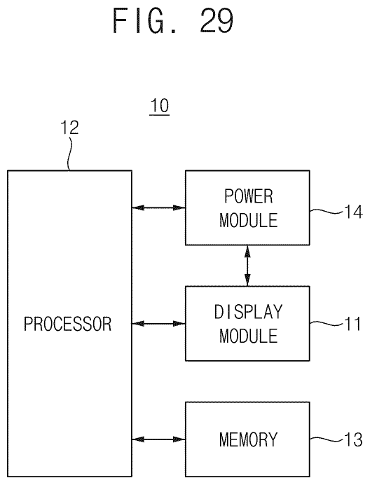

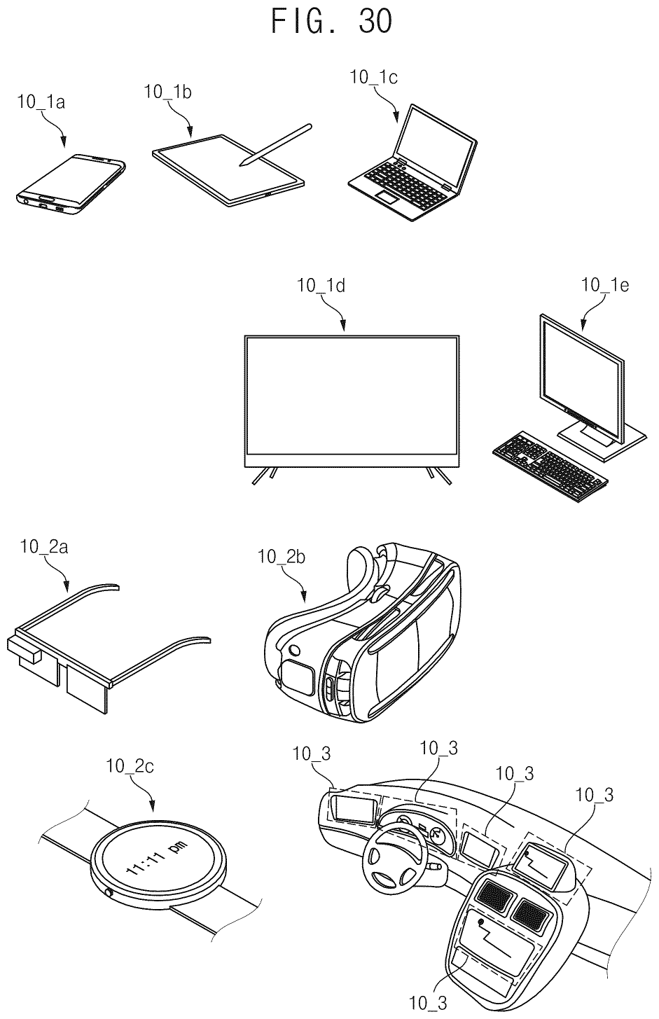

FIG. 29 is a block diagram showing an electronic device 10 according to embodiments of the present inventive concept. FIG. 30 is a schematic diagram of an electronic device 10 of FIG. 29.

Referring to FIG. 29, the electronic device 10 according to the embodiments of the present inventive concept may include a display module 11, a processor 12, a memory 13, and a power module 14.

The display device 1 according to the embodiment of the present inventive concept may be applied to various electronic devices.

In an embodiment, the electronic device 10 may include a display device 1 of FIG. 1. For example, operations of the display device included in the electronic device 10 may be the same as the operations of the display device 1 described with reference to FIGS. 1 to 26. In addition to the display device, a module or device having other additional functions may be further included.

The processor 12 may include at least one of a Central Processing Unit (CPU), an Application Processor (AP), a Graphic Processing Unit (GPU), a Communication Processor (CP), an Image Signal Processor (ISP), and a controller.

In an embodiment, the processor 12 may provide an input control signal CONT of FIG. 1 and input image data IMG of FIG. 1 to the driving controller 200 included in the display device 1 of FIG. 1.

In an embodiment, the processor 12 may be provided by being divided into two or more from a functional or structural viewpoint. For example, the processor 12 may include a main processor in a form of a first drive chip including the central processing unit, and an auxiliary processor in a form of a second drive chip including the controller which receives an image signal from the main processor and processes the image signal to match interface specifications of the display module 11. For example, the auxiliary processor may include the driving controller 200 included in the display device 1 of FIG. 1. Therefore, the main processor may provide the input control signal CONT of FIG. 1 and the input image data IMG of FIG. 1 to the auxiliary processor. The auxiliary processor may process the image signal based on the input control signal CONT and the input image data IMG.

The memory 13 may include at least one of a nonvolatile memory and a volatile memory. The memory 13 may store a data information necessary for an operation of the processor 12 or the display module 11. When the processor 12 executes an application stored in the memory 13, the input control signal CONT and/or the input image data IMG are transmitted to the display module 11, and the display module 11 may process the input control signal CONT and/or the input image data IMG to provide an output image information through a display screen.

The power module 14 may include a power supply module such as a power adapter or a battery device, and a power conversion module which converts power supplied by the power supply module to generate a power necessary for an operation of the electronic device 10.

At least one of components of the electronic device 10 may be included in the display device 1 according to embodiments of the present inventive concept. In addition, some of individual modules functionally included in one module may be included in the display device 1, and other parts may be provided separately from the display device 1. For example, the display device 1 may include the display module 11, and the processor 12, the memory 13, and the power module 14 may be provided in the form of other devices within the electronic device 10 rather than the display device 1.

Referring to FIG. 30, various electronic devices to which the display device 1 according to the present embodiments is applied may include not only image display electronic devices such as a smart phone 10_1a, a tablet PC 10_1b, a laptop 10_1c, a TV 10_1d, and a desk monitor 10_1e, but also wearable electronic devices including display modules such as smart glasses 10_2a, a head mounted display 10_2b, and a smart watch 10_2c, and vehicle electronic devices 10_3 including display modules such as a CID (Center Information Display) and a Room Mirror Display disposed on a dashboard, center fascia, and car instrument panel. The electronic device 10 is not limited to an image display electronic device, a wearable electronic device, and a vehicle electronic device 10_3.

The foregoing is illustrative of the inventive concept and is not to be construed as limiting thereof. Although a few embodiments of the inventive concept have been described, those skilled in the art will readily appreciate that modifications are possible in the embodiments without materially departing from the novel teachings and advantages of the inventive concept. Accordingly, all such modifications are intended to be included within the scope of the inventive concept as defined in the appended claims and their equivalents.

What is claimed is:

1. A pixel circuit, comprising:
a first transistor including a first gate electrode connected to a first node, a first electrode connected to receive a first power supply voltage, a second electrode connected to a second node, and a second gate electrode connected to a third node;
a second transistor configured to connect a data line and the first node in response to a data write gate signal;
a third transistor configured to provide a reference voltage to the third node in response to a compensation gate signal;
a first capacitor including a first electrode connected to the first node and a second electrode connected to the second node;
a second capacitor including a first electrode connected to the second node and a second electrode connected to the third node; and
a light emitting element including an anode connected to the second node and a cathode connected to receive a second power supply voltage.

2. The pixel circuit of claim 1, wherein the first to third transistors are NMOS transistors.

3. The pixel circuit of claim 1, wherein the second transistor includes a gate electrode connected to receive the data write gate signal, a first electrode connected to the data line, and a second electrode connected to the first node.

4. The pixel circuit of claim 1, wherein the third transistor includes a gate electrode connected to receive the compensation gate signal, a first electrode connected to receive the reference voltage, and a second electrode connected to the third node.

5. The pixel circuit of claim 1, wherein the first gate electrode of the first transistor is a gate electrode and the second gate electrode of the first transistor is a back gate electrode.

6. The pixel circuit of claim 1, wherein the first gate electrode of the first transistor is a back gate electrode and the second gate electrode of the first transistor is a gate electrode.

7. The pixel circuit of claim 1, wherein the pixel circuit further comprises a fourth transistor configured to connect the first node and the second node in response to a second compensation gate signal.

8. The pixel circuit of claim 7, wherein the fourth transistor includes a gate electrode connected to receive the second compensation gate signal, a first electrode connected to the first node, and a second electrode connected to the second node.

9. The pixel circuit of claim 7, wherein the pixel circuit further comprises a fifth transistor configured to provide an initialization voltage to the second node in response to an initialization gate signal.

10. The pixel circuit of claim 9, wherein the fifth transistor includes a gate electrode connected to receive the initialization gate signal, a first electrode connected to receive the initialization voltage, and a second electrode connected to the second node.

11. A pixel circuit, comprising:
a first transistor including a first gate electrode connected to a first node, a first electrode connected to receive a first power supply voltage, a second electrode connected to a second node, and a second gate electrode connected to the second node;
a first capacitor including a first electrode connected to the first node and a second electrode connected to a third node;
a second transistor configured to connect a data line and the third node in response to a data write gate signal;
a third transistor configured to provide a reference voltage to the first node in response to a compensation gate signal;
a fourth transistor configured to connect the second node and the third node in response to the compensation gate signal;
a second capacitor including a first electrode connected to the second node and a second electrode connected to the third node; and
a light emitting element including an anode connected to the second node and a cathode connected to receive a second power supply voltage.

12. The pixel circuit of claim 11, wherein the first to fourth transistors are NMOS transistors.

13. The pixel circuit of claim 11, wherein the second transistor includes a gate electrode connected to receive the data write gate signal, a first electrode connected to the data line, and a second electrode connected to the third node.

14. The pixel circuit of claim 11, wherein the third transistor includes a gate electrode connected to receive the compensation gate signal, a first electrode connected to receive the reference voltage, and a second electrode connected to the first node.

15. The pixel circuit of claim 11, wherein the fourth transistor includes a gate electrode connected to receive the compensation gate signal, a first electrode connected to the second node, and a second electrode connected to the third node.

16. A display device, comprising:
a display panel including a pixel circuit;
a gate driver configured to provide a gate signal to the pixel circuit;
a data driver configured to provide a data voltage to the pixel circuit; and
a driving controller configured to control the gate driver and the data driver,
wherein the pixel circuit comprises:
a first transistor including a first gate electrode connected to a first node, a first electrode connected to receive a first power supply voltage, a second electrode connected to a second node, and a second gate electrode connected to a third node;
a second transistor configured to connect a data line and the first node in response to a data write gate signal;
a third transistor configured to provide a reference voltage to the third node in response to a compensation gate signal;
a first capacitor including a first electrode connected to the first node and a second electrode connected to the second node;
a second capacitor including a first electrode connected to the second node and a second electrode connected to the third node; and
a light emitting element including an anode connected to the second node and a cathode connected to receive a second power supply voltage.

17. The display device of claim 16, wherein the first to third transistors are NMOS transistors.

18. The display device of claim 16, wherein the second transistor includes a gate electrode connected to receive the data write gate signal, a first electrode connected to the data line, and a second electrode connected to the first node.

19. The display device of claim 16, wherein the third transistor includes a gate electrode connected to receive the compensation gate signal, a first electrode connected to receive the reference voltage, and a second electrode connected to the third node.

20. The display device of claim 16, wherein the first gate electrode of the first transistor is a gate electrode and the second gate electrode of the first transistor is a back gate electrode.
